(19) United States
(12) Patent Application Publication
(10) Pub. No.: US 2011/0178721 A1
(43) Pub. Date: Jul. 21, 2011

(54) MEANS AND METHODS FOR DETECTING ANTIBIOTIC RESISTANT BACTERIA IN A SAMPLE

(75) Inventors: Moshe Ben-David, Tel-Aviv (IL); Gallya Gannot, Ramat HaSharon (IL); Tomer Eruv, Kfar Tapuah (IL); Zvi Markowitz, Jerusalem (IL)

(73) Assignee: OPTICUL DIAGNOSTICS LTD., Tel Aviv (IL)

(21) Appl. No.: 13/120,343

(22) PCT Filed: Oct. 11, 2009
(86) PCT No.: PCT/IL2009/000960

§ 371 Date: Mar. 22, 2011

(30) Foreign Application Priority Data
Oct. 7, 2008 (IL) 194617

(51) Int. Cl. G06F 19/00

(52) U.S. Cl. 702/19

(57) ABSTRACT

The present invention provides a method for detecting and/or identifying specific bacteria within an uncultured sample, comprising steps of: a. obtaining an absorption spectrum (AS) of said uncultured sample; b. acquiring the n dimensional volume boundaries for said specific bacteria; c. data processing said AS; i. noise reducing; ii. extracting m features from said entire AS; iii. dividing said AS into several segments according to said m features; iv. calculating m₁ features of each of said segment; and, d. detecting and/or identifying said specific bacteria if said m₁ features and/or said m features are within said n dimensional volume; wherein said bacteria is a antibiotics resistance bacteria.

### FIELD OF THE INVENTION

The present invention relates to the field of spectroscopic medical diagnostics of specific antibiotic resistance bacteria within a sample. More particularly, the present invention provides means and methods for differentiating among antibiotic resistant bacteria and the same bacteria that is sensitive to antibiotics. The detection can be used for both medical and non-medical applications, such as detecting antibiotics resistance bacteria in water, beverages, food production lines, sensing for hazardous materials in crowded places etc.

### BACKGROUND OF THE INVENTION

The identification of microorganisms is clearly of great importance in the medical fields, especially the detection of antibiotics resistance microorganisms. It is well known that health care facilities invest large efforts to prevent patient from being infected with secondary diseases especially those relate to antibiotic resistant bacteria. Furthermore, in recent years the need for efficient and relatively rapid identification techniques has become even more pressing owing to the remarkable expansion of environmental and industrial microbiology.

The common method to distinguish between antibiotic resistant bacteria and antibiotic sensitive bacteria is using PCR directly from the sample or after culturing the sample. The result time of these methods is at least one hour and it requires a proffecianal technician to perform.

The bacterial analysis will determine what is the desired and correct treatment and medication.

Usually the physician desires to know if the bacteria is present and then perscribe the correct treatment, antibiotics or isolation. Therefore, it will be beneficial for the doctor and the patient alike to get an immidiate response for the sample.

An immindiate response might be obtained by taking a sample (saliva, mucos, nose swabs, samples from wounds etc.) and optically characterizing their content. Optically characterizing the sample will likely be fater and easier to perform than PCR and culture analysis.

Some spectroscopic techniques, not specific to antibiotics resistance microorganisms already known in the art. For example, PCT No. WO 98/41842 to NELSON, Wilfred discloses a system for the detection of bacteria antibody complexes. The sample to be tested for the presence of bacteria is placed in a medium which contains antibodies attached to a surface for binding to specific bacteria to form an antigen—antibody complex. The medium is contacted with an incident beam of light energy. Some of the energy is emitted from the medium as a lower resonance enhanced Raman backscattered energy. The detection of the presence or absence of the microorganism is based on the characteristic spectral peak of said microorganism. In other words PCT No. WO 98/41842 uses UV resonance Raman spectroscopy.

U.S. Pat. No. 6,599,715 to Laura A. Vanderberg relates to a process for detecting the presence of viable bacterial spores in a sample and to a spore detection system. The process includes placing a sample in a germination medium for a period of time sufficient for commitment of any present viable bacterial spores to occur. Then the sample is mixed with a solution of a lanthanide capable of forming a fluorescent complex with dipicolinic acid. Lastly, the sample is measured for the presence of dipicolinic acid.

U.S. Pat. No. 4,847,198 to Wilfred H. Nelson; discloses a method for the identification of a bacterium. Firstly, taxonomic markers are excited in a bacterium with a beam of ultra violet energy. Then, the resonance enhance Raman back scattered energy is collected substantially in the absence of fluorescence. Next, the resonance enhanced Raman back scattered energy is converted into spectra which corresponds to the taxonomic markers in said bacterium. Finally, the spectra are displayed and thus the bacterium may be identified.

U.S. Pat. No. 6,379,920 to Mostafa A. El-Sayed discloses a method to analyze and diagnose specific bacteria in a biologic sample by using spectroscopic means. The method includes obtaining the spectra of a biologic sample of a non-infected patient for use as a reference, subtracting the reference from the spectra of an infected sample, and comparing the fingerprint regions of the resulting differential spectrum with reference spectra of bacteria. Using this diagnostic technique, U.S. Pat. No. 6,379,920 claims to identify specific bacteria without culturing.

Naumann et at had demonstrated bacteria detection and classification in dried samples using FTIR spectroscopy [Naumann D. et al., “Infrared spectroscopy in microbiology”, Encyclopedia of Analytical Chemistry, R. A. Meyers (Ed.) pp. 102-131, John Wiley & Sons Ltd, Chichester, 2000.]. Marshall et al had identifies live microbes using FTIR Raman spectroscopy [Marshall et al “Vibrational spectroscopy of extant and fossil microbes: Relevance for the astrobiological exploration of Mars”, Vibrational Spectroscopy 41 (2006) 182-189]. Others methods involve fluorescence spectroscopy of a combination of the above.

There are some techniques for distinguishing bacteria and even antibiotics resistance bacteria. One of them is polymerase chain reaction (PCR) patented in U.S. Pat. No. 4,683,202 in 1987. However, such techniques distinguish and/or identify bacteria by amplifying at least one specific nucleic acid sequence contained in a nucleic acid or a mixture of nucleic acids. They do not relate to optically detecting the bacteria.

Another method is by detecting the proteome, i.e., different proteins expressed by a genome. However said methods, again, does not relate to optically detecting the bacteria.

Furthermore, there is a lot of patent literature which relates to different. DNA-based methods for universal bacterial detection, for specific detection of the common bacterial pathogens. An example of such teaching is US application no. US20050042606. Another, another patent literature relates to detection viable bacteria in biological samples by exposing bacterial cultures obtained from the samples to transducing particles having a known host range. An example of such teaching is PCT application no. WO9004041.

Furthermore, there is patent literature which does not relate to the bacteria detection, but to the prediction of the antibiotic effectiveness of a composition. An example of such teaching can be found in US application no. US20030013104.

None of the prior art literature discloses means and method that can quickly (less than one hour) and without the need for professional technician detect antibiotics resistance bacteria from a sample. Furthermore, none of the prior art literature discloses means and method that can eliminate the water influence from the sample so as to better detect the antibiotics resistance bacteria. Moreover all of the above require a skilled operator and/or the use of reagents or a complicated sample preparation for the detection of bacteria.

Thus, there is along felt need for means and method for accurate antibiotics resistance bacteria identification from an uncultured sample without the use of reagents and/or complicated sample preparation.

### SUMMARY OF THE INVENTION

It is one object of the present invention to provide a method for detecting and/or identifying specific bacteria within an uncultured sample. The method comprises steps selected inter alia from:
a. obtaining an absorption spectrum (AS) of said uncultured sample;
b. acquiring the n dimensional volume boundaries for said specific bacteria by
   i. obtaining at least one absorption spectrum (AS2) of known samples containing said specific bacteria;
   ii. extracting x features from said entire AS2; said x features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; x is an integer higher or equal to one; x is an integer greater than or equal to one;
   iii. dividing said AS2 into several segments according to said x features;
   iv. calculating y features of each of said segment of said AS2; said y features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; y is an integer higher or equal to one;
   v. assigning at least one of said x features and/or at least one of said y features to said specific bacteria by algorithms selected from a group consisting of Sequential Backward Selection, Sequential Forward Selection, Sequential Forward Floating Selection (SFFS), Max-Min algorithm, trace(S_{b})/trace(S_{w}); S_{w}/(S_{b}+S_{w}); Kullback-Lieber divergence; correct classification rate; and any combination thereof;
   vi. defining n dimensional space; n equals the sum of said x and said y features;
   vii. defining the n dimensional volume in said n dimensional space;
   viii. determining said boundaries of said n dimensional volume by using technique selected from a group consisting of Bayes classifier, Support Vector Machine (SVM), Linear discriminant, functions and Fisher's linear discriminant, C4.5 algorithm tree, Gaussian Mixed Model (GMM), K-nearest neighbor, Weighted K-nearest neighbor, Hierarchical clustering algorithm, K-mean clustering algorithm, Ward's clustering algorithm, Minimum least square, Neural-Network or any combination thereof;
c. data processing said AS;
   i. noise reducing by using different smoothing techniques selected from a group consisting of running average savitzky-golay, low pass filter or any combination thereof;
   ii. extracting m features from said entire AS; said m features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; m is an integer higher or equal to one;
   iii. dividing said AS into several segments according to said m features;
   iv. calculating m₁ features of each of said segment; said m₁ features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; m₁ is an integer greater than or equal to one; and,
d. detecting and/or identifying said specific bacteria if said m₁ features and/or said m features are within said n dimensional volume;
wherein said bacteria is a antibiotics resistance bacteria.

It is another object of the present invention to provide the method as defined above, additionally comprising step of selecting said x feature and/or said y features via algorithms selected form Chi-Squared, χ2, test, Wilcoxon test, and t-test or any combination thereof.

It is another object of the present invention to provide the method as defined above, wherein said sample is an aerosol or solid or liquid sample selected from a group consisting of cough, sneeze, saliva, mucus, bile, urine, vaginal secretions, middle ear aspirate, pus, pleural effusions, synovial fluid, abscesses, cavity swabs, serum, blood and spinal fluid.

It is another object of the present invention to provide the method as defined above, wherein said step of acquiring the n dimensional volume boundaries for the specific bacteria, additionally comprising step of calculating the Gaussian distribution and/or Multivariate Gaussian distribution, and/or Rayleigh distribution, and/or Maxwell distribution, and/or Estimate the distribution by the Parzen method or mixed model (like the Gaussian Mixed Model known as GMM) for at least one of the n features such that the distributions defines the n dimensional volume in the n dimensional space.

It is another object of the present invention to provide the method as defined above, wherein said step (c) of data processing said AS additionally comprising steps of:
i. calculating at least one of the o^{th} derivative of said AS; said o is an integer greater than or equals 1;
ii. extracting m₂ features from said entire o^{th} derivative spectrum; said m₂ features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; m₂ is an integer greater than or equal to one;
   iii. dividing said o^{th} derivative into several segments according to said m₂ features;
   iv. calculating the m₃ features in at least one of said segments; said m₃ features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; m₂ is an integer greater than or equal to one; and,
   v. detecting and/or identifying said specific bacteria if said m₁ and/or m₃ features and/or said m and/or said m₂ features are within said n dimensional volume.

It is another object of the present invention to provide the method as defined above, additionally comprising the step of selecting said specific bacteria from a group consisting of Gram negative pathogens such as Various types of Acinetobacter (for example: A. baumannii), Stenotrophomonas maltophilia, Gram positive pathogens such as Streptococcus pneumonia resistant to β lactamase and macrolides, Streptococcus viridians group resistant to β lactamase and aminoglycosides, enterococci resistant to vancomycin and teicoplanin and highly resistant to penicillins and aminoglycosides (for example: Enterococcus Faecium, Enterococcus Faecalis), staphylococcus aureus SENSITIVE AND resistant to methicillin, other B lactams, macrolides, lincosamides and aminoglicozides. Streptococcus pyogenes resistant to macrolides, macrolide-resistant streptococci of groups B,C and G. Coagulase negative staphylococci resistant to β lactams, aminoglycosides, macrolides, lincosamides and glycopeptides, multiresistant strains of Listeria and corynebacterium, Peptostreptococcus and clostridium (FOR EXAMPLE: C. Difficile), resistant to penicillins and macrolides, Haemophilus Influenza resistant to lactamase, Pseudomonas Aeruginosa, Stenotrophomonas Maltophilia, Klebsiella Pneumonia resistant to antibiotics (for example: Klebsiella Pneumonia Resistant to carbapenem), Klebsiella. Pneumonia sensitive to antibiotics, aminoglycosides and macrolides or any combination thereof.

It is another object of the present invention to provide the method as defined above, wherein said step of obtaining the AS additionally comprising steps of:
a. providing at least one optical cell accommodates said uncultured sample;
b. providing p light source selected from a group consisting of laser, lamp, LEDs tunable lasers, monochrimator, p is an integer equal or greater than 1; said p light source are adapted to emit light to said optical cell;
c. providing detecting means for receiving the spectroscopic data of said sample;
d. emitting light from said light source at different wavelength to said optical cell; and,
e. collecting said light exiting from said optical cell by said detecting means; thereby obtaining said AS.

It is another object of the present invention to provide the method as defined above, wherein said step of emitting light is performed at the wavelength range of UV, visible, IR, mid-IR, far-IR and terahertz.

It is another object of the present invention to provide a method for detecting and/or identifying specific bacteria within an uncultured sample. The method:comprises steps selected inter alia from:
a. obtaining an absorption spectrum (AS) of said uncultured sample; said AS containing water influence;
b. acquiring the n dimensional volume boundaries for said specific bacteria by:
   i. obtaining at least one absorption spectrum (AS2) of known samples containing said specific bacteria;
   ii. extracting x features from said AS2; said x features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; x is an integer higher or equal to one; x is an integer greater than or equal to one;
   iii. calculating at least one derivative of said AS2;
   iv. dividing said AS2 into several segments according to said x features;
   v. calculating the y features of each of said segment; said y features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; y is an integer higher or equal to one;
   vi. assigning at least one of said x features and/or at least one of said y features to said-specific bacteria by algorithms selected from a group consisting of Sequential Backward Selection, Sequential Forward Selection, Sequential Forward Floating Selection (SFFS), Max-Min algorithm, trace(S_{b})/trace(S_{w}); S_{w}/(S_{b}+S_{w}); Kullback-Lieber divergence; correct classification rate; and any combination thereof;
   vii. defining n dimensional space; n equals the sum of said x features and said y features;
   viii. defining the n dimensional volume in said n dimensional space;
   ix. determining said boundaries of said n dimensional volume by using technique selected from a group consisting of Bayes classifier, Support Vector Machine (SVM), Linear discriminant, functions and Fisher's linear discriminant, C4.5 algorithm tree, K-nearest neighbor, Weighted K-nearest neighbor, Hierarchical clustering algorithm, Gaussian Mixed Model (GMM), K-mean clustering algorithm, Ward's clustering algorithm, Minimum least square, Neural-Network or any combination thereof;
c. eliminating said water influence from said AS by at least one of the following methods: Low pass filter, High pass filter and Water absorption division;
d. data processing said AS without said water influence by
   i. noise reducing by using different smoothing techniques selected from a group consisting of running average savitzky golay, low pass filter or any combination thereof;
   ii. extracting m features from said entire AS; said m features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; m is an integer greater or equal to one;
   iii. dividing said AS into several segments according to said m features;
   iv. calculating the m₁ features of at least one of said segment; said m₁ features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; m₁ is an integer greater than or equal to one; and,
e. detecting and/or identifying said specific bacteria if said m₁ features and/or said m features are within said n dimensional volume;
wherein said bacteria is a antibiotics resistance bacteria.

It is another object of the present invention to provide the method as defined above, additionally comprising step of selecting said x feature and/or said y features via algorithms selected form Chi-Squared, χ2, test, Wilcoxon test, and t-test or any combination thereof.

It is another object of the present invention to provide the method as defined above, wherein said sample is an aerosol or solid or liquid sample selected from a group consisting of cough, sneeze, saliva, mucus, bile, urine, vaginal secretions, middle ear aspirate, pus, pleural effusions, synovial fluid, abscesses, cavity swabs, serum, blood and spinal fluid.

It is another object of the present invention to provide the method as defined above, wherein said step of acquiring the n dimensional volume boundaries for the specific bacteria, additionally, comprising step of calculating the Gaussian distribution and/or Multivariate Gaussian distribution, and/or Rayleigh distribution, and/or Maxwell distribution, and/or Estimate the distribution by the Parzen method or mixed model (like the Gaussian Mixed Model known as GMM) for at least one of the n features such that the distributions defines the n dimensional volume in the n dimensional space.

It is another object of the present invention to provide the method as defined above, wherein said step (c) of data processing said AS without said water influence, additionally comprising steps of
i. calculating at least one of the o^{th} derivative of said AS; said o is an integer greater than or equals 1;
ii. extracting m₂ features from said entire o^{th} derivative spectrum; said m₂ features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; m₂ is an integer greater than or equal to one;
iii. dividing said o^{th} derivative into several segments according to said m₂ features;
iv. calculating the m₃ features in at least one of said segments; said m₃ features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; m₂ is an integer greater than or equal to one; and,
v. detecting and/or identifying said specific bacteria if said m₁ and/or m₃ features and/or said m and/or said m₂ features are within said n dimensional volume.

It is another object of the present invention to provide the method as defined above, additionally comprising the step of selecting said specific bacteria selected from a is selected from a group consisting of Gram negative pathogens such as Various types of Acinetobacter (for example: A. baumannii), Stenotrophomonas maltophilia, Gram positive pathogens such as Streptococcus pneumonia resistant to β lactamase and macrolides, Streptococcus viridian group resistant to β lactamase and aminoglycosides, enterococci resistant to vancomycin and teicoplanin and highly resistant to penicillins and aminoglycosides (for example: Enterococcus Faecium, Enterococcus Faecalis), staphylococcus aureus SENSITIVE AND resistant to methicillin, other B lactams, macrolides, lincosamides and aminoglicozides. Streptococcus pyogenes resistant to macrolides, macrolide-resistant streptococci of groups B, C and G. Coagulase negative staphylococci resistant to β lactams, aminoglycosides, macrolides, lincosamides and glycopeptides, multiresistant strains of Listeria and corynebacterium, Peptostreptococcus and clostridium (FOR EXAMPLE: C. Difficile), resistant to penicillins and macrolides, Haemophilus Influenza resistant to β lactamase, Pseudomonas Aeruginosa, Stenotrophomonas Maltophilia, Klebsiella Pneumonia resistant to antibiotics (for example: Klebsiella Pneumonia Resistant to carbapenem), Klebsiella Pneumonia sensitive to antibiotics, aminoglycosides and macrolides or any combination thereof.

It is another object of the present invention to provide the method as defined above, wherein said step of obtaining the AS additionally comprising steps of:
a. providing at least one optical cell accommodating said uncultured sample;
b. providing p light source selected from a group consisting of laser, lamp, LEDs tunable lasers, monochrimator, p is an integer equal or greater than 1; said p light source are adapted to emit light to said optical cell;
c. providing detecting means for receiving the spectroscopic data of said sample;
d. emitting light from said light source at different wavelength to said optical cell;
e. collecting said light exiting from said optical cell by said detecting means; thereby obtaining said AS.

It is another object of the present invention to provide the method as defined above, wherein said step of emitting light is performed at the wavelength range of UV, visible, IR, mid-IR, far IR and terahertz.

It is another object of the present invention to provide the method as defined above, wherein the absorption spectra is obtained using an instrument selected from the group consisting of a spectrometer, Fourier transform infrared spectrometer, a fluorometer and a Raman spectrometer.

It is another object of the present invention to provide the method as defined above, wherein said sample is taken from the human body.

It is another object of the present invention to provide a system 1000 adapted to detect and/or identify specific bacteria within an uncultured sample. The system comprises:
a. means 100 for obtaining an absorption spectrum (AS) of said uncultured sample;
b. statistical processing means 200 for acquiring the n dimensional volume boundaries for said specific bacteria; said means 200 are characterized by:
   i. means 201 for obtaining at least one absorption spectrum (AS2) of known samples containing said specific bacteria;
   ii. means 202 for extracting x features from said entire AS2; said ‘x features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; x is an integer higher or equal to one;
   iii. means 203 for dividing said AS2 into several segments according to said x features;
   iv. means 204 for calculating y features from at least one of each of said segment; said y features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; y is an integer higher or equal to one;
   v. means 205 for assigning at least one of said x features and/or at least one of said y features to said specific bacteria by algorithms selected from a group consisting of Sequential Backward Selection, Sequential Forward Selection, Sequential Forward Floating Selection (SFFS), Max-Min algorithm, trace(S_{b})/trace(S_{w}); S_{w}/(S_{b}+S_{w}); Kullback-Lieber divergence; correct classification rate; and any combination thereof;
   vi. means 206 for defining n dimensional space; n equals the sum of said x features and said y features;
   i. means 207 for defining the n dimensional volume in the n dimensional space;
   vii. means 208 for determining said boundaries of said n dimensional volume by using technique selected from a group consisting of Bayes classifier, Support Vector Machine (SVM), Linear discriminant, functions and Fisher's linear discriminant, C4.5 algorithm tree, K-nearest neighbor, Weighted K-nearest neighbor, Hierarchical clustering algorithm, Gaussian Mixed Model (GMM), K-mean clustering algorithm, Ward's clustering algorithm, Minimum least square, Neural-Network or any combination thereof;
   viii. means 209 for assigning the n dimensional volume to said specific bacteria;
c. means 300 for data processing said AS; said means 300 are characterized by
   i. means 301 for noise reducing by using different smoothing techniques selected from a group consisting of running average savitzky-golay, low pass filter or any combination thereof;
   ii. means 302 for extracting m features from said entire AS; said m features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; m is an integer higher or equal to one;
   iii. means 303 for dividing said AS into several segments according to said m features;
   iv. means 304 for calculating the m₁ features of at least one of said segment; said m₁ features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; m₁ is an integer greater than or equal to one; and,
d. means 400 for detecting and/or identifying said specific bacteria if said m₁ features and/or said m features are within said n dimensional volume;
wherein said bacteria is an antibiotics resistance bacteria.

It is another object of the present invention to provide the system as defined above, additionally comprising means for selecting said x feature and/or said y features via algorithms selected form Chi-Squared, χ2, test, Wilcoxon test, and t-test or any combination thereof.

It is another object of the present invention to provide the system as defined above, wherein said sample is an aerosol or solid or liquid sample selected from a group consisting of cough, sneeze, saliva, mucus, bile, urine, vaginal secretions, middle ear aspirate, pus, pleural effusions, synovial fluid, abscesses, cavity swabs, serum, blood and spinal fluid.

It is another object of the present invention to provide the system as defined above, wherein said statistical processing means 200 additionally comprising means 210 for calculating the Gaussian distribution or Multivariate Gaussian distribution, or Rayleigh distribution, or Maxwell distribution, or Estimate the distribution by the Parzen method or by mixed model (like the Gaussian Mixed Model known as GMM) for at least one of the n features such that the distributions defines the n dimensional volume in the n dimensional space.

It is another object of the present invention to provide the system as defined above, wherein said means 300 for data processing said AS additionally characterized by:
i. means 305 for calculating at least one of the o^{th} derivative of said AS; said o is an integer greater than or equals 1;
ii. means 306 for extracting m₂ features from said entire o^{th} derivative spectrum; said m₂ features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; m₂ is an integer greater than or equal to one;
iii. means 307 for dividing said o^{th} derivative into several segments according to said m₂ features;
iv. means 308 for calculating the m₃ features in at least one of said segments; said m₃ features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; m₂ is an integer greater than or equal to one; and,
v. means 309 for detecting and/or identifying said specific bacteria if said m₁ and/or m₃ features and/or said m and/or said m₂ features are within said n dimensional volume.

It is another object of the present invention to provide the system as defined above, wherein said specific bacteria is selected from a is selected from a group consisting of Gram negative pathogens such as Various types of Acinetobacter (for example: A. baumannii), Stenotrophomonas maltophilia, Gram positive pathogens such as Streptococcus pneumonia resistant to β lactamase and macrolides, Streptococcus viridians group resistant to β lactamase and aminoglycosides, enterococci resistant to vancomycin and teicoplanin and highly resistant to penicillins and aminoglycosides (for example: Enterococcus Faecium, Enterococcus Faecalis), staphylococcus aureus SENSITIVE AND resistant to methicillin, other B lactams, macrolides, lincosamides and aminoglicozides. Streptococcus pyogenes resistant to macrolides, macrolide-resistant streptococci of groups B,C and G. Coagulase negative staphylococci resistant to β lactams, aminoglycosides, macrolides, lincosamides and glycopeptides, multiresistant strains of Listeria and corynebacterium, Peptostreptococcus and clostridium (FOR EXAMPLE: C. Difficile), resistant to penicillins and macrolides, Haemophilus Influenza resistant to β lactamase, Pseudomonas Aeruginosa, Stenotrophomonas Maltophilia, Klebsiella Pneumonia resistant to antibiotics (for example: Klebsiella Pneumonia Resistant to carbapenem), Klebsiella Pneumonia sensitive to antibiotics, aminoglycosides and macrolides or any combination thereof.

It is another object of the present invention to provide the system as defined above, wherein said means 100 for obtaining an absorption spectrum (AS) of said sample additionally comprising:
a. at least one optical cell for accommodating said uncultured sample;
b. p light source selected from a group consisting of laser, lamp, LEDs tunable lasers, monoclirimator, p is an integer equal or greater than 1; said p light source are adapted to emit light at different wavelength to said optical cell; and,
c. detecting means for receiving the spectroscopic data of said sample exiting from said optical cell.

It is another object of the present invention to provide the system as defined above, wherein said p light source are adapted to emit light at wavelength range selected from a group consisting of UV, visible, IR, mid-IR, far-IR and terahertz.

It is another object of the present invention to provide a system 2000 adapted to detect and/or identify specific bacteria within an uncultured sample; said system 2000 comprising:
a. means 100 for obtaining an absorption spectrum (AS) of said uncultured sample; said AS containing water influence;
b. statistical processing means 200 for acquiring the n dimensional volume boundaries for said specific bacteria; said means 200 are characterized by:
   i. means 201 for obtaining at least one absorption spectrum (AS2) of known samples containing said specific bacteria;
   ii. means 202 for extracting x features from said entire AS2; said x features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; x is an integer higher or equal to one; x is an integer greater than or equal to one;
   iii. means 203 for dividing said AS2 into several segments according to said x features;
   iv. means 204 for calculating the y features of at least one of said segments; said y features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; y is an integer higher or equal to one;
   v. means 205 for assigning at least one of said x features and/or at least one of said y features to said specific bacteria by algorithms selected from a group consisting of Sequential Backward Selection, Sequential Forward Selection, Sequential Forward Floating Selection (SFFS), Max-Min algorithm, trace(S_{b})/trace(S_{w}); S_{w}/(S_{b}+S_{w}); Kullback-Lieber divergence; correct classification rate; and any combination thereof;
   vi. means 206 for defining n dimensional space; n equals the sum of said x features and said y features;
   vii. means 207 for defining the n dimensional volume in said n dimensional space;
   viii. means 208 for determining said boundaries of said n dimensional volume by using technique selected from a group consisting of Bayes classifier, Support Vector Machine (SVM), Linear discriminant, functions and Fisher's linear discriminant, C4.5 algorithm tree, K-nearest neighbor, Weighted K-nearest neighbor, Hierarchical clustering algorithm, Gaussian Mixed Model (GMM), K-mean clustering algorithm, Ward's clustering algorithm, Minimum least square, Neural-Network or any combination thereof;
   ix. means 209 for assigning said n dimensional volume to said specific bacteria;
c. means 300 for eliminating said water influence from said AS selected from a group consisting of; Low pass filter, High pass filter and Water absorption division
d. means 400 for data processing said AS without said water influence; said means 400 are characterized by:
   i. means 401 for noise reducing by using different smoothing techniques selected from a group consisting of running average savitzky-golay, low pass filter or any combination thereof;
   ii. means 402 for extracting m features from said entire AS; said m features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; m is an integer greater than or equal to one;
   iii. means 403 for dividing said AS into several segments according to said m features;
   iv. means 404 for calculating m₁ features at least one of said segments; said m₁ features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; m₁ is an integer greater than or equal to one; and,
e. means 500 for detecting and/or identifying said specific bacteria if said m₁ features and/or said m features are within said n dimensional volume;
wherein said bacteria is a antibiotics resistance bacteria.

It is another object of the present invention to provide the system as defined above, additionally comprising means for selecting said x feature and/or said y features via algorithms selected form Chi-Squared, χ2, test, Wilcoxon test, and t-test or any combination thereof.

It is another object of the present invention to provide the system as defined above, wherein said sample is an aerosol or solid or liquid sample selected from a group consisting of cough, sneeze, saliva, mucus, bile, urine, vaginal secretions, middle ear aspirate, pus, pleural effusions, synovial fluid, abscesses, cavity swabs, serum, blood and spinal fluid.

It is another object of the present invention to provide the system as defined above, wherein said statistical processing means 200 additionally comprising means 210 for calculating the Gaussian distribution or Multivariate Gaussian distribution, or Rayleigh distribution, or Maxwell distribution, or Estimate the distribution by the Parzen method or by mixed model (like the Gaussian Mixed Model known as GMM) for at least one of the n features such that the distributions defines the n dimensional volume in the n dimensional space.

It is another object of the present invention to provide the system as defined above, wherein said means 400 for data processing said AS without said water influence additionally comprising:
i. means 405 for calculating at least one of the o^{th} derivative of said AS; said o is an integer greater than or equals 1;
ii. means 406 for extracting m₂ features from said entire o^{th} derivative spectrum; said m₂ features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; m₂ is an integer greater than or equal to one;
iii. means 407 for dividing said o^{th} derivative into several segments according to said m₂ features;
iv. means 408 for calculating the m₃ features from at least one of said segments; said m₃ features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; m₂ is an integer greater than or equal to one; and,
v. means 409 for detecting and/or identifying said specific bacteria if said m₁ and/or m₃ features and/or said m and/or said m₂ features are within said n dimensional volume.

It is another object of the present invention to provide the system as defined above, wherein said specific bacteria is selected from a is selected from a group consisting of Gram negative pathogens such as Various types of Acinetobacter (for example: A. baumannii), Stenotrophomonas maltophilia, Gram positive pathogens such as Streptococcus pneumonia resistant to β lactamase and macrolides, Streptococcus viridians group resistant to β lactamase and aminoglycosides, enterococci resistant to vancomycin and teicoplanin and highly resistant to penicillins and aminoglycosides (for example: Enterococcus Faecium, Enterococcus Faecalis), staphylococcus aureus SENSITIVE AND resistant to methicillin, other B lactams, macrolides, lincosamides and aminoglicozides. Streptococcus pyogenes resistant to macrolides, macrolide-resistant streptococci of groups B, C and G. Coagulase negative staphylococci resistant to β lactams, aminoglycosides, macrolides, lincosamides and glycopeptides, multiresistant strains of Listeria and corynebacterium, Peptostreptococcus and clostridium (FOR EXAMPLE: C. Difficile), resistant to penicillins and macrolides, Haemophilus Influenza resistant to β lactamase, Pseudomonas Aeruginosa, Stenotrophomonas Maltophilia, Klebsiella Pneumonia resistant to antibiotics (for example: Klebsiella Pneumonia Resistant to carbapenem), Klebsiella Pneumonia sensitive to antibiotics, aminoglycosides and macrolides or any combination thereof.

It is another object of the present invention to provide the system as defined above, wherein said means 100 for obtaining an absorption spectrum (AS) of said sample additionally comprising:
a. at least one optical cell for accommodating said uncultured sample;
b. p light source selected from a group consisting of laser, lamp, LEDs tunable lasers, monochrimator, p is an integer equal or greater than 1; said p light source are adapted to emit light at different wavelength to said optical cell; and,
c. detecting means for receiving the spectroscopic data of said sample exiting from said optical cell.

It is another object of the present invention to provide the system as defined above, wherein said p light source are adapted to emit light at wavelength range selected from a group consisting of UV, visible, IR, mid-IR, far-IR and terahertz.

It is another object of the present invention to provide the system as defined above, wherein the absorption spectra is obtained using an instrument selected from the group consisting of a spectrometer, Fourier transform infrared spectrometer, a fluorometer and a Raman spectrometer.

It is another object of the present invention to provide the system as defined above, wherein said sample is taken from the human body.

It is another object of the present invention to provide the system as defined above, additionally comprising means adapted to recommend, after the specific bacteria has been identified, what kind of antibiotics and medicine to take.

It is another object of the present invention to provide the methods as defined above, additionally comprising step of recommending, after the specific bacteria has been identified, what kind of antibiotics and medicine to take.

It is another object of the present invention to provide the system as defined above, wherein said sample is a sample obtained from air moisture and/or contaminations in air condition systems.

It is another object of the present invention to provide the methods as defined above, wherein said sample is an sample obtained from air moisture and/or contaminations in air condition systems.

It is still an object of the present invention to provide the methods as defined above, additionally comprising the step of detecting said bacteria by analyzing said AS in the region of about 3000-3300 cm⁻¹ and/or about 850-1000 cm⁻¹ and/or about 1300-1350 cm⁻¹, and/or about 2836-2995 cm⁻¹, and/or about 1720-1780 cm⁻¹, and/or about 1550-1650 cm⁻¹, and/or about 1235-1363 cm⁻¹, and/or about 990-1190 cm⁻¹ and/or about 1500-1800 cm⁻¹ and/or about 2800-3050 cm⁻¹ and/or about 1180-1290 cm⁻¹.

It is lastly an object of the present invention to provide the system as defined above, wherein said identification is preformed in the region of about 3000-3300 cm⁻¹ and/or about 850-1000 cm⁻¹ and/or about 1300-1350 cm⁻¹, and/or about 2836-2995 cm⁻¹, and/or about 1720-1780 cm⁻¹, and/or about 1550-1650 cm⁻¹, and/or about 1235-1363 cm⁻¹, and/or about 990-1190 cm⁻¹ and/or about 1500-1800 cm⁻¹ and/or about 2800-3050 cm⁻¹ and/or about 1180-1290 cm⁻¹.

### BRIEF DESCRIPTION OF THE FIGURES

In order to understand the invention and to see how it may be implemented in practice, a plurality of embodiments will now be described, by way of non-limiting example only, with reference to the accompanying drawings, in which

FIGS. 1-2 illustrate a system 1000 and 2000 respectfully for detecting and/or identify bacteria within an aerosol sample according to preferred embodiments of the present invention.

FIGS. 3-4 illustrate an absorption spectrum prior to the water influence elimination (FIG. 3) and after the water influence elimination (FIG. 4) whilst using the first method.

FIGS. 5-7 illustrate the second method for eliminating the water influence.

FIGS. 8-9 illustrate the third method for eliminating the water influence.

FIGS. 10a, 10b and 11 illustrate the absorption spectrum of Meticylin Sensitive Staphylococcus Aurous (MSSA) and Meticylin Resistant Staphylococcus Aurous (MRSA) respectfully.

FIGS. 12a and 12b illustrate the possibility of distinguishing between the MRSA bacteria and MSSA bacteria.

FIGS. 13-15 illustrate the manner FIG. 12 was achieved.

FIG. 16 illustrates the differentiation between Enterococcus Faecium sensitive to Vancomycin and Enterococcus Faecium Resistant to Vancomycin.

FIG. 17 illustrates the differentiation between Enterococcus faecalis_sensitive to Vancomycin and Enterococcus faecalis_{—} Resistant to Vancomycin.

FIG. 18 illustrates the differentiation between Acinetobacter sensitive to antibiotic and Acinetobacter Resistant to antibiotics.

FIG. 19 illustrates the differentiation between KP Sen (i.e, sensitive to antibiotics),-KP Res (resistant to antibiotics) and KPC (Resistant to carbapenem (more resistant then the previous type)).

FIG. 20 illustrates the differentiation between samples of blood with MRSA and MSSA.

FIG. 21 illustrates the differentiation between nose swabs samples spiked with MRSA and MSSA.

FIG. 22 illustrates the differentiation between axillary swabs spiked with MRSA and MSSA.

### DETAILED DESCRIPTION OF THE PREFERRED EMBODIMENTS

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide means and methods for detecting bacteria within a sample by using Spectroscopic measurements.

Spectroscopic measurements, whether absorption fluorescence Raman, and scattering are the bases for all optical sensing devices. In order to identify a hazardous material (for example a bacteria) in a sample that might contain the material, the sample is placed inside a spectrometer and the absorption spectrum of the sample is then analyzed to verify whether the spectral signature of the hazardous material is recognized.

The present invention provides means and methods for detection or identification of bacteria by analyzing the absorption spectra of a sample which might contain bacteria.

The term “sample” refers herein to a liquid or an aerosol or a solid sample. The present invention provides accurate detection means that enable the detection of bacteria in the sample. The detection means can be used for medical or non-medical applications. Furthermore, the detection means can be used, for example, in detecting bacteria in bodily samples, water, beverages, food production, sensing for hazardous materials in crowded places etc.

The sample will be obtained from coughing, sneezing, saliva, bile, mucus, urine, nose swabs, throat swabs, blood (, blood Serum or spinal fluid, vaginal secretions, middle ear aspirate, pus, pleural effusions, synovial fluid, abscesses, cavity swabs, serum.

Furthermore, the samples will be obtained from air moisture (hazardous materials such as soot, metals), contaminations in air condition systems, water, fluids and solids that are sampled.

The present invention will provides means and method for detecting antibiotic resistant bacteria.

It should be emphasized that the sample can be selected from a group consisting of an aerosol sample, solid sample or a liquid sample.

The term “High-pass filter (HPF)” refers hereinafter to a filter that passes high frequencies well, but attenuates (reduces the amplitude of) frequencies lower than a cutoff frequency.

The term “Low-pass filter (LPF)” refers hereinafter to a filter that passes low-frequency signals but attenuates (reduces the amplitude of) signals with frequencies higher than a cutoff frequency.

The term “Chi-Squared, χ2, test” refers hereinafter to any statistical hypothesis test in which the sampling distribution of the test statistic is a chi-square distribution when the null hypothesis is true, or any in which this is asymptotically true, meaning that the sampling distribution (if the null hypothesis is true) can be made to approximate a chi-square distribution as closely as desired by making the sample size large enough. The term “Pearson's correlation coefficient” refers hereinafter to the correlation between two variables that reflects the degree to which the variables are related. Pearson's correlation reflects the degree of linear relationship between two variables. It ranges from +1 to −1. A correlation of —1 means that there is a perfect negative linear relationship between variables. A correlation of 0 means there is no linear relationship between the two variables. A correlation of 1 means there is a complete linear relationship between the two variables.

A commonly used formula for computing Pearson's correlation coefficient r is the following one:

$$r = \frac{\sum XY - \frac{\sum X \sum Y}{N}}{\sqrt{( \sum {X}^{2} - \frac{{( \sum X )}^{2}}{N} ) ( \sum {Y}^{2} - \frac{{( \sum Y )}^{2}}{N} )}}$$

The term “about” refers hereinafter to a range of 25% below or above the referred value.

The term “segments” refers hereinafter to wavelength ranges within the absorption spectrum.

The term “n dimensional volume” refers hereinafter to a volume in an n dimensional space that is especially adapted to identify the bacteria under consideration. The n dimensional volume is constructed by extracting features and correlations from the absorption spectrum or its derivatives.

The term “n dimensional space” refers hereinafter to a space where each coordinate is a feature extracted from the bacteria spectral signature or calculated out of the spectrum and its derivatives or from a segment of the spectrum and/or its derivatives.

The term “n dimensional volume boundaries” refers hereinafter to a range that includes about 95% of the bacteria under consideration possible features and correlation values.

The term “trace(S_{b})/trace(S_{w})” refers hereinafter to the ratio between interclass and intraclass covariance matrix. It refers to a method used to measure the separability of two classes. It relates to the ability to achieve high correct classification in a designed classifier. In the following disclosure S_{b} is the covariance matrix reflecting the distance between two classes, and S_{w} is covariance matrix reflecting the distance within class.

The term “Correlation” refers herein after to correlation between the aerosol bacteria spectrum and a reference bacteria spectrum which is already known, correlation between bacteria spectrum without the water influence and a reference bacteria spectrum which is already known, correlation between o^{th} derivative of the aerosol bacteria spectrum and a reference bacteria spectrum which is already known, correlation between o^{th} derivative of the bacteria spectrum without the water influence and a reference bacteria spectrum which is already known. o is an integer greater than or equals to 1. The above correlations are calculated on the whole spectrum and/or segments of the spectrum and/or their derivatives.

Methods and means for bacteria detection adapted to utilize the unique spectroscopic signature of microbes/bacteria and thus enables the detection of the antibiotic resistant microbes/bacteria within a sample are provided by the present invention.

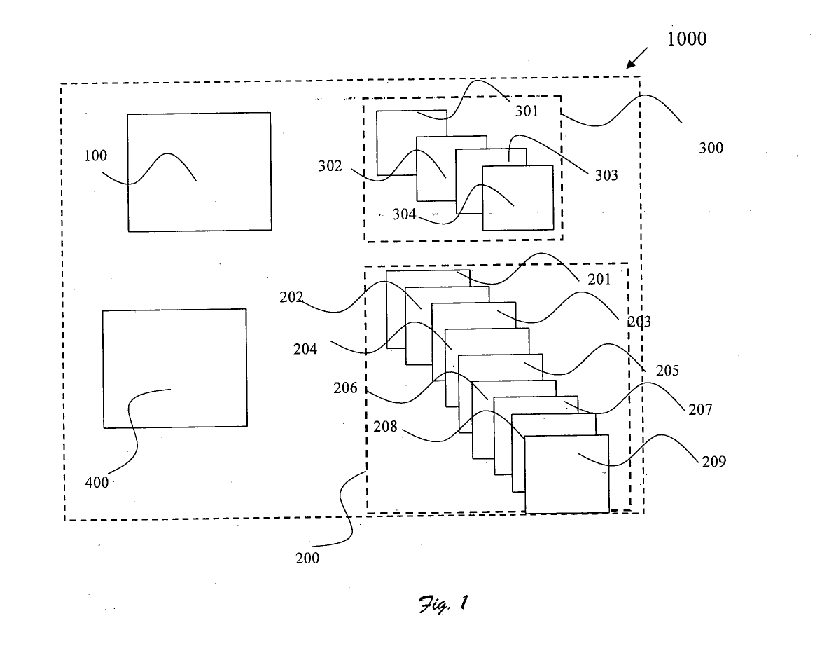

Reference is now made to FIG. 1, illustrating a system 1000 adapted to detect and/or identify specific bacteria within a sample according to one preferred embodiment of the present invention. System 1000 comprises:
a. means 100 for obtaining an absorption spectrum (AS) of the sample;
b. statistical processing means 200 for acquiring the n dimensional volume boundaries of at least specific bacteria, having:
   i. means 201 for obtaining at least one absorption spectrum (AS2) of known samples containing the specific bacteria;
   ii. means 202 for extracting x features from the entire AS2; said x features are selected from a group consisting of Correlation peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of patameters different peaks' intensity ratios, wavelet coefficients or any combination thereof; x is an integer higher or equal to one;
   iii. means 203 for dividing the AS2 into several segments according to at least one of the x features;
   iv. means 204 for extracting y features from at least one of said segments; said y features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; y is an integer higher or equal to one;
   v. means 205 for assigning at least one of said x features and/or at least one of said y features to said specific bacteria by algorithms selected from a group consisting of Sequential Backward Selection, Sequential. Forward Selection, Sequential Forward Floating Selection (SFFS), Max-Min algorithm, trace(S_{b})/trace(S_{w}); S_{w}/(S_{b}+S_{w}); Kullback-Lieber divergence; correct classification rate; and any combination thereof;
   vi. means 206 for defining n dimensional space; n equals the sum of the x and y;
   vii. means 207 for defining the n dimensional volume in the n dimensional space;
   viii. means 208 for determining the boundaries of the n dimensional volume by using technique selected from a group consisting of Bayes classifier, Support Vector Machine (SVM), Linear discriminant, functions and Fisher's linear discriminant, C4.5 algorithm tree, Gaussian Mixed Model (GMM), K-nearest neighbor, Weighted K-nearest neighbor, Hierarchical clustering algorithm, K-mean clustering algorithm, Ward's clustering algorithm, Minimum least square, Neural-Network or any combination thereof;
   ix. means 209 for assigning the n dimensional volume to the specific bacteria;
c. means 300 for data processing the AS, having:
   i. means 301 for noise reducing by using different smoothing techniques selected from a group consisting of running average savitzky-golay, low pass filter or any combination thereof;
   ii. means 302 for extracting m features from the entire AS; said m features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; m is an integer higher or equal to one;
   iii. means 303 for dividing the AS into several segments according to the m features;
   iv. means 304 for extracting m₁ features from at least one of said segments; said m₁ features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; m₁ is an integer greater than or equal to one; and,
d. means 400 for detecting and/or identifying the specific bacteria if the m₁ and/or m features are within the n dimensional volume; wherein said bacteria is an antibiotics resistance bacteria.

According to another embodiment of the present invention, the method as defined above, additionally comprising step of selecting said x feature and/or said y features via algorithms selected form Chi-Squared, χ2, test, Wilcoxon test, and t-test or any combination thereof.

According to another embodiment of the present invention, the sample is an aerosol or solid or liquid sample selected from a group consisting of cough, sneeze, saliva, mucus, bile, urine, vaginal secretions, middle ear aspirate, pus, pleural effusions, synovial fluid, abscesses, cavity swabs, serum, blood and spinal fluid.

According to another embodiment of the present invention, the statistical processing means 200 additionally comprising means 210 (not illustrated in the figures) for calculating the Gaussian distribution or Multivariate Gaussian distribution, or Rayleigh distribution, or Maxwell distribution, Estimate the distribution by the Parzen method or mixed model (like the Gaussian Mixed Model known as GMM) for at least one of the n features such that the distributions defines the n dimensional volume in the n dimensional space.

According to another embodiment of the, present invention, means 300 (in system 1000) for data processing the AS additionally characterized by:
i. means 305 (not illustrated in the figures) for calculating at least one of the o^{th} derivative of the AS; o is an integer greater than or equals 1;
ii. means 306 (not illustrated in the figures) for extracting m₂ features from the entire o^{th} derivative spectrum; said m₂ features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; m₂ is an integer greater than or equal to one;
iii. means 307 (not illustrated in the figures) for dividing the o^{th} derivative into several segments according to the m₂ features;
iv. mean 308 (not illustrated in the figures) for extracting m₃ features from at least one of said segments; said m₃ features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; m₂ is an integer greater than or equal to one; and,
v. means 309 (not illustrated in the figures) for detecting and/or identifying the specific bacteria if the m₁ and/or m₃ and/or the m and/or the m₂ features are within the n dimensional volume.

According to yet another embodiment of the present invention, the specific bacteria to be identified by system 1000 is selected from a is selected from a group consisting of Gram negative pathogens such as Various types of Acinetobacter (for example: A. baumannii), Stenotrophomonas maltophilia, Gram positive pathogens such as Streptococcus pneumonia resistant to β lactamase and macrolides, Streptococcus viridians group resistant to β lactamase and aminoglycosides, enterococci resistant to vancomycin and teicoplanin and highly resistant to penicillins and aminoglycosides (for example: Enterococcus Faecium, Enterococcus Faecalis), staphylococcus aureus SENSITIVE AND resistant to methicillin, other B lactams, macrolides, lincosamides and aminoglicozides. Streptococcus pyogenes resistant to macrolides, macrolide-resistant streptococci of groups B,C and G. Coagulase negative staphylococci resistant to β lactams, aminoglycosides, macrolides, lincosamides and glycopeptides, multiresistant strains of Listeria and corynebacterium, Peptostreptococcus and clostridium (FOR EXAMPLE: C. Difficile), resistant to penicillins and macrolides, Haemophilus Influenza resistant to β lactamase, Pseudomonas Aeruginosa, Stenotrophomonas Maltophilia, Klebsiella Pneumonia resistant to antibiotics (for example: Klebsiella Pneumonia Resistant to carbapenem), Klebsiella Pneumonia sensitive to antibiotics, aminoglycosides and macrolides or any combination thereof.

According to another embodiment of the present invention, the means 100 for obtaining an absorption spectrum (AS) of the sample (in system 1000), additionally comprising:
a. at least one optical cell for accommodating the sample;
b. p light source selected from a group consisting of laser, lamp, LEDs tunable lasers, monochrimator, p is an integer equal or greater than 1; the p light source are adapted to emit light at different wavelength to the optical cell; and,
c. detecting means for receiving the spectroscopic data of the sample exiting from the optical cell.

According to yet another embodiment of the present invention, the p light source (in system 1000) are adapted to emit light at wavelength range selected from a group consisting of UV, visible, IR, mid-IR, far-IR and terahertz.

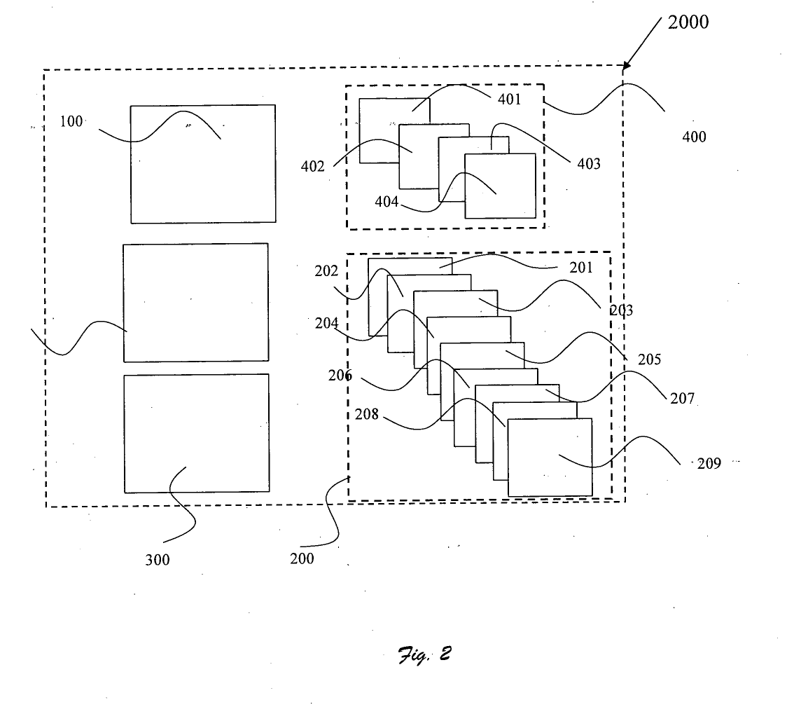

Reference is now made to FIG. 2, illustrating a system 2000 adapted to detect and/or identify specific bacteria within a sample, according to another preferred embodiment of the present invention. System 2000 comprises:
a. means 100 for obtaining an absorption spectrum (AS) of the sample; the AS containing water influence;
b. statistical processing means 200 for acquiring the n dimensional volume boundaries for at least one specific bacteria, having:
   i. means 201 for obtaining at least one absorption spectrum (AS2) of known samples containing the specific bacteria;
   i. means 202 for extracting x features from the entire AS2; said x features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; x is an integer higher or equal to one; x is an integer greater than or equal to one;
   ii. means 203 for dividing the AS2 into several segments according to at least one of the x features;
   iii. means 204 for extracting y features from at least one of said segments; said y features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; y is an integer higher or equal to one;
   iv. means 205 for assigning at least one of said x features and/or at least one of said y features to said specific bacteria;
   v. means 206 for defining n dimensional space; n equals the sum of the x and y;
   vi. means 207 for defining the n dimensional volume in said n dimensional space;
   vii. means 208 for determining the boundaries of the n dimensional volume by using technique selected from a group consisting of Bayes classifier, Support Vector Machine (SVM), Linear discriminant, functions and Fisher's linear discriminant, C4.5 algorithm tree, Gaussian Mixed Model (GMM), K-nearest neighbor, Weighted K-nearest neighbor, Hierarchical clustering algorithm, K-mean clustering algorithm, Ward's clustering algorithm, Minimum least square, Neural-Network or any combination thereof;
   viii. means 209 for assigning the n dimensional volume to the specific bacteria;
c. means 300 for eliminating the water influence from the AS, selected from a group consisting of; Low pass filter, High pass filter and Water absorption division;
d. means 400 for data processing the AS without the water influence, characterized by:
   i. means 401 for noise reducing by using different smoothing techniques selected from a group consisting of running average savitzky-golay, low pass filter or any combination thereof;
   ii. means 402 for extracting m features from the entire AS; said m features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; m is an integer greater or equal to one;
   iii. means 403 for dividing the AS into several segments according to the m features;
   iv. means 404 for extracting m₁ features from at least one of said segments; said m₁ features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; m₁ is an integer greater than or equal to one; and,
e. means 500 for detecting and/or identifying the specific bacteria if the m₁ and/or m features are within the n dimensional volume; wherein said bacteria is an antibiotics resistance bacteria.

According to another embodiment of the present invention, the sample is an aerosol or solid or liquid sample selected from a group consisting of cough, sneeze, saliva, mucus, bile, urine, vaginal secretions, middle ear aspirate, pus, pleural effusions, synovial fluid, abscesses, cavity swabs, serum, blood and spinal fluid.

According to another embodiment of the present invention, the selection of said x feature and/or said y features is performed via algorithms selected form Chi-Squared, χ2, test, Wilcoxon test, and t-test or any combination thereof.

According to another embodiment of the present invention, the statistical processing means 200 in system 2000) additionally comprising means 210 (not illustrated in the figures) for calculating the Gaussian distribution or Multivariate Gaussian distribution, or Rayleigh distribution, or Maxwell distribution, Estimate the distribution by the Parzen method or mixed model (like the Gaussian Mixed Model known as GMM) for at least one of the n features such that the distributions defines the n dimensional volume in the n dimensional space.

According to another embodiment of the present invention, means 400 (in system 2000) for data processing the AS without the water influence additionally comprising:
ii. means 405 (not illustrated in the figures) for calculating at least one of the o^{th} derivative of the AS; o is an integer greater than or equals 1;
iii. means 406 (not illustrated in the figures) for extracting m₂ features from the entire o^{th} derivative spectrum; said m₂ features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; m₂ is an integer greater than or equal to one;
iv. means 407 (not illustrated in the figures) for dividing the o^{th} derivative into several segments according to the m₂ features;
v. mean 408 (not illustrated in the figures) for extracting m₃ features from at least one of said segments; said m₃ features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; m₂ is an integer greater than or equal to one; and,
vi. means 409 (not illustrated in the figures) for detecting and/or identifying the specific bacteria if the m₁ and/or m₃ and/or the m and/or the m₂ features are within the n dimensional volume.

According to another embodiment of the present invention, the specific bacteria (in system 2000) is selected from a is selected from a group consisting of Gram negative pathogens such as Various types of Acinetobacter (for example: A. baumannii), Stenotrophomonas maltophilia, Gram positive pathogens such as Streptococcus pneumonia resistant to β lactamase and macrolides, Streptococcus viridian group resistant to β lactamase and aminoglycosides, enterococci resistant to vancomycin and teicoplanin and highly resistant to penicillins and amino glycosides (for example: Enterococcus Faecium, Enterococcus Faecalis), staphylococcus aureus SENSITIVE AND resistant to methicillin, other B lactams, macrolides, lincosamides and aminoglicozides. Streptococcus pyogenes resistant to macrolides, macrolide-resistant streptococci of groups B, C and G. Coagulase negative staphylococci resistant to β lactams, aminoglycosides, macrolides, lincosamides and glycopeptides, multiresistant strains of Listeria and corynebacterium, Peptostreptococcus and clostridium (FOR EXAMPLE: C. Difficile), resistant to penicillins and macrolides, Haemophilus Influenza resistant to β lactamase, Pseudomonas Aeruginosa, Stenotrophomonas Maltophilia, Klebsiella Pneumonia resistant to antibiotics (for example: Klebsiella Pneumonia Resistant to carbapenem), Klebsiella Pneumonia sensitive to antibiotics, aminoglycosides and macrolides or any combination thereof.

According to another embodiment of the present invention, means 100 for obtaining an absorption spectrum (AS) of the sample additionally comprising:
a. at least one optical cell for accommodating the sample;
b. p light source selected from a group consisting of laser, lamp, LEDs tunable lasers, monochrimator, p is, an integer equal or greater than 1; p light source are adapted to emit light at different wavelength to the optical cell; and,
c. detecting means for receiving the spectroscopic data of the sample exiting from the optical cell.

According to yet another embodiment of the present invention, the p light source are adapted to emit light at wavelength range selected from a group consisting of UV, visible, IR, mid-IR, far-IR and terahertz.

According to yet another embodiment of the present invention, identification is preformed in the region, of about 3000-3300 cm⁻¹ and/or about 850-1000 cm⁻¹ and/or about 1300-1350 cm⁻¹, and/or about 2836-2995 cm⁻¹, and/or about 1720-1780 cm⁻¹, and/or about 1550-1650 cm⁻¹, and/or about 1235-1363 cm⁻¹, and/or about 990-1190 cm⁻¹ and/or about 1500-1800 cm⁻¹ and/or about 2800-3050 cm⁻¹ and/or about 1180-1290 cm^{31 1}.

Yet another object of the present invention is to provide a method for detecting and/or identifying specific bacteria within a sample. The method comprises step selected inter alia from:
a. obtaining an absorption spectrum (AS) of the sample;
b. acquiring the n dimensional volume boundaries for the specific bacteria by:
   i. obtaining at least one absorption spectrum (AS2) of samples containing the specific bacteria;
   ii. extracting x features from the entire AS2; said x features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; x is an integer higher or equal to one; x is an integer greater than or equal to one;
   iii. dividing the AS2 into several segments according to the x features;
   iv. extracting y features from of each of the segment of AS2; said y features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; y is an integer higher or equal to one;
   v. assigning at least one of said x features and/or at least one of said y features to said specific bacteria by algorithms selected from a group consisting of Sequential Backward Selection, Sequential Forward Selection, Sequential Forward Floating Selection (SFFS), Max-Min algorithm, trace(S_{b})/trace(S_{w}); S_{w}/(S_{b}+S_{w}); Kullback-Lieber divergence; correct classification rate; and any combination thereof;
   vi. defining n dimensional space; n equals the sum of the x features and/or they features;
   vii. defining the n dimensional volume in said n dimensional space;
   viii. determining the boundaries of the n dimensional volume by using technique selected from a group consisting of Bayes classifier, Support Vector Machine (SVM), Linear discriminant, functions and Fisher's linear discriminant, C4.5 algorithm tree, Gaussian Mixed Model (GMM), K-nearest neighbor, Weighted K-nearest neighbor, Hierarchical clustering algorithm, K-mean clustering algorithm, Ward's clustering algorithm, Minimum least square, Neural-Network or any combination thereof.
c. data processing the AS;
   i. noise reducing by using different smoothing techniques selected, from a group consisting of running average savitzky-golay, low pass filter or any combination thereof;
   ii. extracting m features from the entire AS; said m features are selected from a group consisting of Correlation, peak's wavelength, peak's height, peak's width, peak's cross Section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; m is an integer higher or equal to one;
   iii. dividing the AS into several segments according to the m features;
   iv. calculating the m₁ features of at least one of the segments; said m₁ features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; m₁ is an integer greater than or equal to one; and,
d. detecting and/or identifying the specific bacteria if the m₁ and/or the m features are within the n dimensional volume.

It should be pointed out that in each of the systems or methods as described above (either 1000 or 2000), the statistical processing means 200 is used only once for each specific bacteria. Once the boundaries were provided by the statistical processing means 200 the determination whether the specific bacteria is present in a sample is performed by verifying whether the m and/or m₂ features are within the boundaries. Furthermore, once the boundaries were provided, there exists no need for the statistical processing of the same specific bacteria again.

It should be further pointed out that according to one embodiment of the present invention, either one of the systems (1000 and/or 2000) as defined above can additionally comprise means adapted to recommend any physician, after the specific bacteria has been identified, what kind of antibiotics and medicine to take.

Yet another object of the present invention is to provide a method for detecting and/or identifying specific bacteria within a sample. The method comprises steps selected inter alia from:
a. obtaining an absorption spectrum (AS) of the sample; the AS containing water influence;
b. acquiring the n dimensional volume boundaries for the specific bacteria by:
   i. obtaining at least one absorption spectrum (AS2) of known samples containing the specific bacteria;
   ii. extracting x features from the entire AS2; said x features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; x is an integer higher or equal to one; x is an integer greater than or equal to one;
   iii. dividing the AS2 into several segments according to the x features;
   iv. Extracting y features from of each of the segment of AS2; said y features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; y is an integer higher or equal to one; v. assigning at least one of said x features and/or at least one of said y features to said specific bacteria
   vi. defining n dimensional space; n equals the sum of the x features and/or they;
   vii. determining the boundaries of the n dimensional volume by using technique selected from a group consisting of Bayes classifier, Support Vector Machine (SVM), Linear discriminant, functions and Fisher's linear discriminant, C4.5 algorithm tree, Gaussian Mixed Model (GMM), K-nearest neighbor, Weighted K-nearest neighbor, Hierarchical clustering algorithm, K-mean clustering algorithm, Ward's clustering algorithm, Minimum least square, Neural-Network or any combination thereof;
c. eliminating the water influence from the AS by at least one of the following methods: Low pass filter, High pass filter and Water absorption division;
d. data processing the AS without the water influence by:
   i. noise reducing by using different smoothing techniques selected from a group consisting of running average savitzky-golay, low pass filter or any combination thereof;
   ii. extracting m features from the entire AS; said m features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; m is an integer greater or equal to one;
   iii. dividing the AS into several segments according to the m features;
   iv. calculating the m₁ features of each of the segment; said m₁ features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; m₁ is an integer greater than or equal to one; and,
e. detecting and/or identifying the specific bacteria if the m₁ and/or the m features are within the n dimensional volume; wherein said bacteria is an antibiotics resistance bacteria.

According to another embodiment, the sample is an aerosol or solid or liquid sample selected from a group consisting of cough, sneeze, saliva, mucus, bile, urine, vaginal secretions, middle ear aspirate, pus, pleural effusions, synovial fluid, abscesses, cavity swabs, serum, blood and spinal fluid.

According to another embodiment, the selection of said x feature and/or said y features is performed via algorithms selected form Chi-Squared, χ2, test, Wilcoxon test, and t-test or any combination thereof.

In each of the methods as described above, the statistical processing is used only once for each specific bacteria. Once the boundaries were provided by the statistical processing the determination whether the specific bacteria is present in a sample is performed by verifying whether the m₁ and/or said m features are within the boundaries. Furthermore, once the boundaries were provided, there exists no need for the statistical processing of the same specific bacteria again.

According to another embodiment of the present invention, the step of acquiring the n dimensional volume boundaries for the specific bacteria in each of the methods as defined above, additionally comprising step of calculating the Gaussian distribution and/or Multivariate Gaussian distribution, and/or Rayleigh distribution, and/or Maxwell distribution, and/or Estimate the distribution by the Parzen method or mixed model (like the Gaussian Mixed Model known as GMM) for at least one of the n features such that the distributions defines the n dimensional volume in the n dimensional space.

According to another embodiment of the present invention step (c) of data processing the AS, in the methods as described above, additionally comprising steps of:
i. calculating at least one of the o^{th} derivative of the AS; o is an integer greater than or equals 1;
ii. extracting m₂ features from the entire o^{th} derivative spectrum; said m₂ features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; m₂ is an integer greater than or equal to one;
iii. dividing the o^{th} derivative into several segments according to the m₂ features;
iv. calculating the m₃ features in at least one of the segments; said m₃ features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; m₂ is an integer greater than or equal to one; and,
v. detecting and/or identifying the specific bacteria if the m₁ and/or m₃ features and/or the m and/or the m₂ features are within the n dimensional volume.

According to another embodiment of the present invention, the methods as described above, additionally comprising the step of selecting the specific bacteria selected from a is selected from a group consisting of Gram negative pathogens such as Various types of Acinetobacter (for example: A. baumannii), Stenotrophomonas maltophilia, Gram positive pathogens such as Streptococcus pneumonia resistant to β lactamase and macrolides, Streptococcus viridians group resistant to β lactamase and aminoglycosides, enterococci resistant to vancomycin and teicoplanin and highly resistant to penicillins and aminoglycosides (for example: Enterococcus Faecium, Enterococcus Faecalis), staphylococcus aureus SENSITIVE AND resistant to methicillin, other B lactams, macrolides, lincosamides and aminoglicozides. Streptococcus pyogenes resistant to macrolides, macrolide-resistant streptococci of groups B, C and G. Coagulase negative staphylococci resistant to β lactams, aminoglycosides, macrolides, lincosamides and glycopeptides, multiresistant strains of Listeria and corynebacterium, Peptostreptococcus and clostridium (FOR EXAMPLE: C. Difficile), resistant to penicillins and macrolides, Haemophilus Influenza resistant to β lactamase, Pseudomonas Aeruginosa, Stenotrophomonas Maltophilia, Klebsiella Pneumonia resistant to antibiotics (for example: Klebsiella Pneumonia Resistant to carbapenem), Klebsiella Pneumonia sensitive to antibiotics, aminoglycosides and macrolides or any combination thereof.

According to another embodiment of the present invention, the step of obtaining the AS, in the methods as described above, additionally comprising the following steps:
a. providing at least one optical cell accommodates the sample;
b. providing p light source selected from a group consisting of laser, lamp, LEDs tunable lasers, monochrimator, p is an integer equal or greater than 1; p light source are adapted to emit light to the optical cell;
c. providing detecting means for receiving the spectroscopic data of the sample;
d. emitting light from the light source at different wavelength to the optical cell; and,
e. collecting the light exiting from the optical cell by the detecting means; thereby obtaining the AS.

According to another embodiment of the present invention, the step of emitting light is performed at the wavelength range of UV, visible, IR, mid-IR, far-IR and terahertz. It should be further pointed out that according to one embodiment of the present invention, the methods as described above, additionally comprising the step of detecting said bacteria by analyzing said AS in the region of about 3000-3300 cm⁻¹ and/or about 850-1000 cm⁻¹ and/or about 1300-1350 cm⁻¹, and/or about 2836-2995 cm⁻¹, and/or about 1720-1780 cm⁻¹, and/or about 1550-1650 cm⁻¹, and/or about 1235-1363 cm⁻¹, and/or about 990-1190 cm⁻¹ and/or about 1500-1800 cm⁻¹ and/or about 2800-3050 cm⁻¹ and/or about 1180-1290 cm⁻¹.

According to yet another embodiment of the present invention, the absorption spectra, in any of the systems (1000 or 2000) or for any of the methods as described above, is obtained using an instrument selected from the group consisting of a spectrometer, Fourier transform infrared spectrometer, a fluorometer and a Raman spectrometer.

According to yet another embodiment of the present invention, the uncultured sample, in any of the systems (1000 or 2000) or for any of the methods as described above, is selected from fluid originated from the human body such as blood, saliva, urine, bile, vaginal secretions, middle ear aspirate, pus, pleural effusions, synovial fluid, abscesses, cavity swabs, mucous, and serum.

It should be further pointed out that according to one embodiment of the present invention, either one of the methods as described above can additionally comprise step of recommending, after the specific bacteria has been identified, what kind of antibiotics and medicine to take.

In the foregoing description, embodiments of the invention, including preferred embodiments, have been presented for the purpose of illustration and description. They are not intended to be exhaustive or to limit the invention to the precise form disclosed. Obvious modifications or variations are possible in light of the above teachings. The embodiments were chosen and described to provide the best illustration of the principals of the invention and its practical application, and to enable one of ordinary skill in the art to utilize the invention in various embodiments and with various modifications as are suited to the particular use contemplated. All such modifications and variations are within the scope of the invention as determined by the appended claims when interpreted in accordance with the breadth they are fairly, legally, and equitably entitled.

### EXAMPLES

Examples are given in order to prove the embodiments claimed in the present invention. The examples describe the manner and process of the present invention and set forth the best mode contemplated by the inventors for carrying out the invention, but are not to be construed as limiting the invention.

### Example 1

### Water Influence

One of the major problems in identifying bacteria from a fluid sample's spectrum (and especially an aerosol spectrum) is the water influence (i.e., the water noise which masks the desired spectrum by the water spectrum).

The water molecule may vibrate in a number of ways. In the gas state, the vibrations involve combinations of symmetric stretch (v1), asymmetric stretch (v3) and bending (v2) of the covalent bonds. The water molecule has a very small moment of inertia on rotation which gives rise to rich combined vibrational-rotational spectra in the vapor containing tens of thousands to millions of absorption lines. The water molecule has three vibrational modes x, y and z. The following table (table 1) illustrates the water vibrations, wavelength and the assignment of each vibration:

TABLE 1
water vibrations, wavelength and the assignment of each vibration

| | | |
|---|---|---|
| Wavelength | cm-1 | Assignment |

| | | | |
|---|---|---|---|
| 0.2 | mm | 50 | intermolecular bend |
| 55 | μm | 183.4 | intermolecular stretch |
| 25 | μm | 395.5 | L1, librations |
| 15 | μm | 686.3 | L2, librations |
| 6.08 | μm | 1645 | v2, bend |
| 4.65 | μm | 2150 | v2 + L2 b |
| 3.05 | μm | 3277 | v1, symmetric stretch |
| 2.87 | μm | 3490 | v3, asymmetric stretch |
| 1900 | nm | 5260 | av1 + v2 + bv3; a + b = 1 |
| 1470 | nm | 6800 | av1 + bv3; a + b = 2 |
| 1200 | nm | 8330 | av1 + v2 + bv3; a + b = 2 |
| 970 | nm | 10310 | av1 + bv3; a + b = 3 |
| 836 | nm | 11960 | av1 + v2 + bv3; a + b = 3 |
| 739 | nm | 13530 | av1 + bv3; a + b = 4 |
| 660 | nm | 15150 | av1 + v2 + bv3; a + b = 4 |
| 606 | nm | 16500 | av1 + bv3; a + b = 5 |
| 514 | nm | 19460 | av1 + bv3; a + b = 6 |

a and b are integers, ≧0 ms.

The present invention provides a method for significantly reducing and even eliminating the water influence within the absorption spectra.

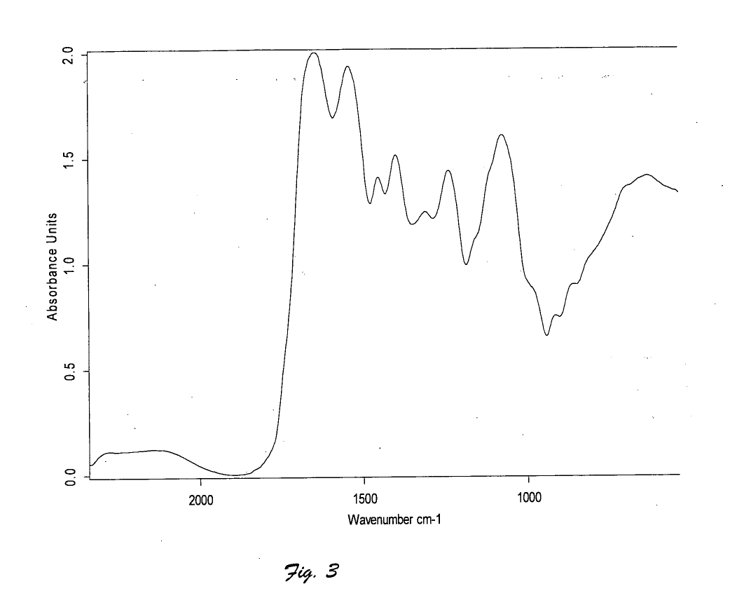

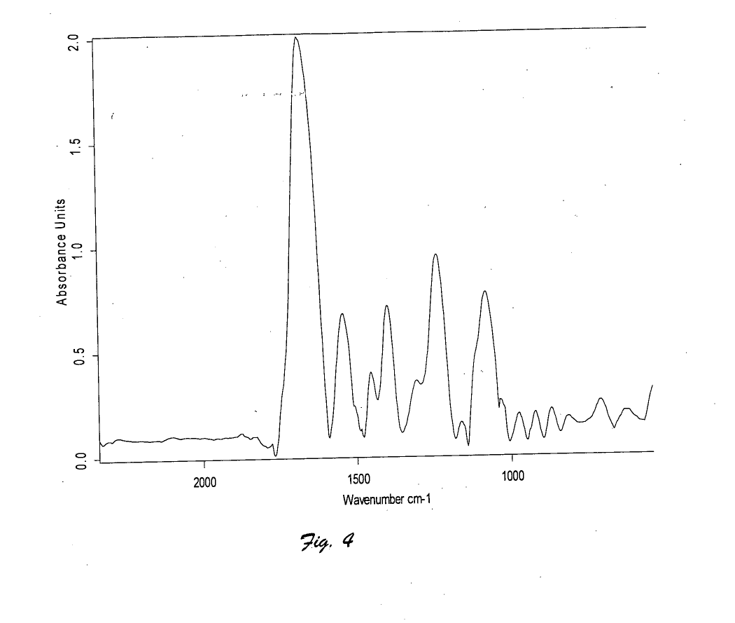

Reference is now made to FIGS. 3 and 4 which illustrate an absorption spectrum of a sample with and without the water influence.

The present invention provides three main methods for eliminating the water influence.

The First Method

The first method for eliminating the water influence uses Water absorption division and contains the following steps:

First the absorption spectrum was divided in several segments (i.e, wavelength ranges). The spectrum was divided to segments (wavenumber ranges) of about 1800 cm⁻¹ to about 2650 cm⁻¹, about 1400 cm⁻¹ to about 1850 cm⁻¹, about 1100 cm⁻¹ to about 1450 cm⁻¹, about 950 cm⁻¹ to about 1100 cm⁻¹, about 550 cm⁻¹ to about 970 cm⁻¹.

The segments were determined according to (i) different intensity peaks within the water's absorption spectrum; and, (ii) the signal's trends.

Next, each segment was eliminated from the water influence in the following manner:
(a) providing the absorption intensity at each of wavenumber (x) within the absorption spectrum (refers hereinafter as Sig_{with water}(x));
(b) calculating the correction factors (CF) at each wavelength (refers hereinafter as x) within each segment (refers hereinafter as CF(x));
(c) acquiring from the absorption spectrum, at least one absorption intensity that is mainly influenced by water (refers hereinafter as Sig_{water only}(x1)) at the corresponding wavenumbers (x1);
(d) calculating at least one correction factor of the water (CF_{water only} (x1)) at said at least one wavenumber (x1);
(e) dividing at least one Sig_{water only}(x1) by at least one CF_{water} (i.e., Sig_{water only}(x1)/CF_{water only} (x1)) at said at least one wavenumber (x1);
(f) calculating the average of the results of step (e) (refers hereinafter as AVG[Sig_{water only}(x1)/CF_{water only}(x1)]);
(g) multiplying the AVG[Sig_{water only}(x1)/CF_{water only}] (x1) by CF(x) for each wavenumber (x); and,
(h) Subtracting each result of step (g) from Sig_{with water}(x) per each (x).

In other words, each absorption intensity within the spectrum is eliminated from the water influence according to the following equation:

Sig_{with water}(x)−(CF(x)*AVG[Sig_{water only}(x1)/CF_{water only}(x1)])

Calculating the Correction Factors

The correction factors (CF) depends on the wavelength range, the water absorption peak's shape at each wavelength, peak's width, peak's height, absorption spectrum trends and any combination thereof. The following series were used as a correction factor (x—denote the wavenumber in cm⁻¹)
1. Wavelength range 1846 cm⁻¹ to 2613 cm⁻¹
Coefficients:
a11=137.2;
b11=2170;
c11=224.3;
a21=19.02;
b21=2063;
c21=37.53;
a31=0.7427;
b31=2224;
c31=13;
a41=98.33;
b41=2124;
c41=109.8;
a51=−4.988;
b51=2192;
c51=33.87;
a61=20.19;
b61=1998;
c61=40.22;
a71=228.3;
b71=1496;
c71=1329;
a81=6.751e+012;
b81=−1226;
c81=592.1;

CF(x)=a11*e^{(-((x-b11/c11)}^{²}⁾+a21*e^{(-((x-b21)/c21)}^{²}⁾+a31*e^{(-((x-b31)/c31)}^{²}⁾+a41*e^{(-((x-b41)/c41)}^{²}⁾+a51*e^{(-((x-b51)/c51)}^{²}²⁾+a61*e^{(-((x-b61)/c61)}^{²}⁾+a71*e^{(-((x-b71)/c71))}^{²}⁾+a81*e^{(-((x-b81)/c81)}^{²}⁾

2. Wavelength range 1461 cm⁻¹ to 1846 cm⁻¹

a12=−300.2;

b12=1650;

c12=13.65;

a22=−51.65;

b22=1665;

c22=6.48;

a32=142.4;

b32=1623;

c32=7.584;

a42=1450;

b42=1649;

c42=32.62;

a52=96.34;

b52=1617;

c52=2.387;

a62=608;

b62=1470;

c62=369.3;

a72=0;

b72=1873;

c72=2.625;

a82=1037;

b82=1644;

c82=76.21;

CF(x)=a12*e^{(-((x-b12/c21)}^{²}⁾+a22*e^{(-((x-b22)/c22)}^{²}⁾+a32*e^{(-((x-b32)/c32)}^{²}⁾+a42*e^{(-((x-b42)/c42)}^{²}⁾+a52*e^{(-((x-b52)/c52)}^{²}²⁾+a62*e^{(-((x-b62)/c62)}^{²}⁾+a72*e^{(-((x-b72)/c72))}^{²}⁾+a82*e^{(-((x-b82)/c82)}^{²}⁾

3. Wavelength range 1111 cm⁻¹ to 1461 cₘ⁻¹

a13=1368;

b13=2167;

c13=767;

a23=80.67;

b23=1356;

c23=68.83;

a33=36.85;

b33=1307;

c33=33.79;

a43=142.5;

b43=1244;

c43=67.19;

a53=260.4;

b53=1130;

c53=88.91;

a63=66.54;

b63=1093;

c63=31;

a73=7.126;

b73=1345;

c73=20.9;

a83=4.897;

b83=1280;

c83=11.05;

CF(x)=a13*e^{(-((x-b13/c13)}^{²}⁾+a23*e^{(-((x-b23)/c23)}^{²}⁾+a33*e^{(-((x-b33)/c33)}^{²}⁾+a43*e^{(-((x-b43)/c43)}^{²}⁾+a53*e^{(-((x-b53)/c53)}^{²}²⁾+a63*e^{(-((x-b63)/c63)}^{²}⁾+a73*e^{(-((x-b73)/c73))}^{²}⁾+a83*e^{(-((x-b83)/c83)}^{²}⁾

4. Wavelength range 961 cm⁻¹ to 1111 cm⁻¹

a14=692.6;

b14=952;

c14=31.04;

a24=48.46;

b24=983.2;

c24=15.72;

a34=287.5;

b34=994.6;

c34=27.98;

a44=434.9;

b44=1032;

c44=40.86;

a54=17.05;

b54=1052;

c54=13.55;

a64=48.61;

b64=1068;

c64=16.56;

a74=70.71;

b74=1086;

c74=21.23;

a84=497.3;

b84=1124;

c84=64.42;

CF(x)=a14*e^{(-((x-b14/c14)}^{²}⁾+a24*e^{(-((x-b24)/c24)}^{²}⁾+a34*e^{(-((x-b34)/c34)}^{²}⁾+a44*e^{(-((x-b44)/c44)}^{²}⁾+a54*e^{(-((x-b54)/c54)}^{²}²⁾+a64*e^{(-((x-b64)/c64)}^{²}⁾+a74*e^{(-((x-b74)/c74))}^{²}⁾+a84*e^{(-((x-b84)/c84)}^{²}⁾

Wavelength range 570 cm⁻¹ to 961 cm⁻¹

a15=−2877;

b15=36.23;

c15=29.09;

a25=0;

b25=−124.3;

c25=22.09;

a35=−190.7;

b35=18.97;

c35=16.45;

a45=1.589e+004;

b45=−3.427;

c45=56.25;

a55=−1.352e+004;

b55=−5.861;

c55=40.75;

a65=476.7;

b65=82.38;

c65=17.29;

a75=1286;

b75=62.29;

c75=180.3;

a85=802.9;

b85=102.8;

c85=18.79;

CF(x)=a15*e^{(-((x-b15/c15)}^{²}⁾+a25*e^{(-((x-b25)/c25)}^{²}⁾+a35*e^{(-((x-b35)/c35)}^{²}⁾+a45*e^{(-((x-b45)/c45)}^{²}⁾+a55*e^{(-((x-b55)/c55)}^{²}²⁾+a65*e^{(-((x-b65)/c65)}^{²}⁾+a75*e^{(-((x-b75)/c75))}^{²}⁾+a85*e^{(-((x-b85)/c85)}^{²}⁾

Absorption Intensity Mainly Influenced by Water

Reference is made again to FIG. 3 which illustrate the absorption spectrum prior to eliminating the water influence.

As can be seen from the figure, the absorption intensity that is mainly influenced by the water is the wavenumber region of 2000 cm⁻¹ and above. The intensity at that region is about 0.2 absorption units. In the present example, x1 is 2000 and Sig_{water only}(x1) is 0.2.

Reference is made again to FIG. 4, which illustrate the absorption spectrum of a sample after the influence of the water was eliminated.

It should be pointed out that for the purpose of obtaining a better resolution both graphs (3 and 4) are normalized to 2 (i.e., multiplied by 2).

The Second Method

The second method uses a low pass filter, LPF. The method comprises the following steps:
1. Selecting the entire spectrum or at least one sub-region of the fully-hydrated bacteria spectrum.
2. Computing a water-baseline spectrum estimate by filtering the selected fully-hydrated bacteria spectrum by a Low-Pass-Filter (LPF).
3. Subtracting the water-baseline spectrum estimate from the selected fully-hydrated bacteria spectrum to obtain the non-smoothed sole bacteria spectrum.
4. A smoothed version of the sole bacteria spectrum is obtained by applying any smoothing operator like Savitzky-Golay, but not limited, on the non-smoothed sole bacteria spectrum.

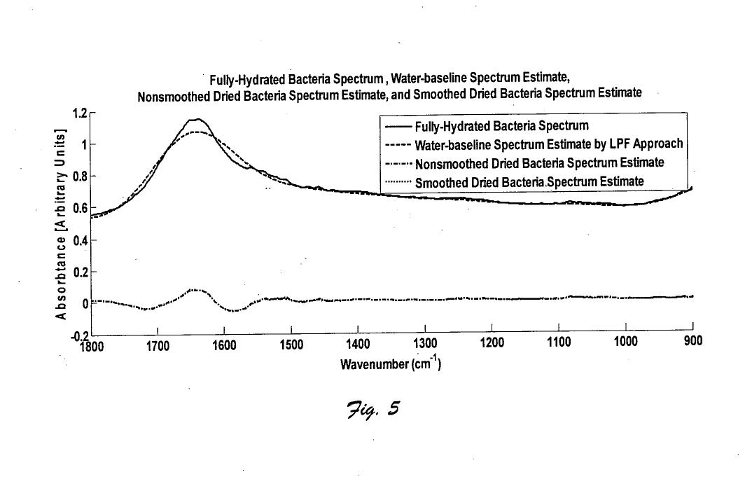

All the steps described above (in the second method) are illustrated in FIGS. 5-7.

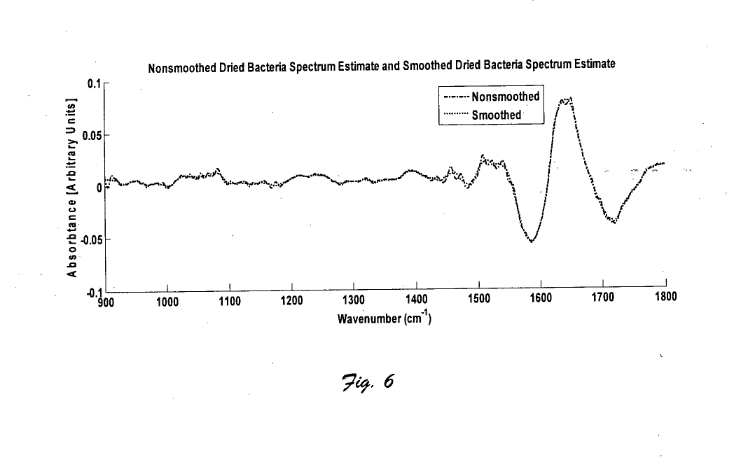

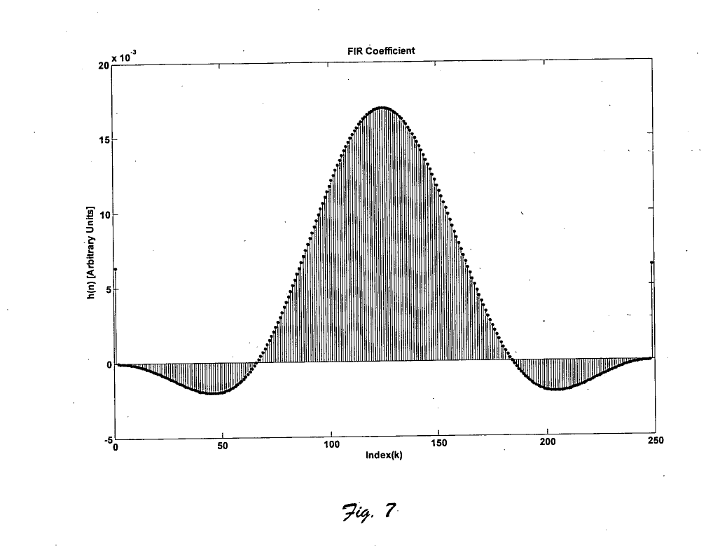

FIG. 5 illustrates steps 1-4. FIG. 6 illustrates the subtracted non smoothed signal and the subtracted smoothed signal. FIG. 7 illustrates Finite-Impulse-Response (FIR) used to generate the LPF coefficients.

The Third Method

The third method uses a high pass filter, HPF. The method comprises the, following steps:
1. Selecting the entire spectrum or a sub-region of the fully-hydrated bacteria spectrum.
2. Computing the sole bacteria spectrum by filtering the selected fully-hydrated bacteria spectrum by a High-Pass-Filter (HPF).
3. Subtracting the sole bacteria, spectrum from the entire spectrum to obtain the non-smoothed sole bacteria spectrum.
4. A smoothed version of the sole bacteria spectrum is obtained by applying any smoothing operator like Savitzky-Golay, but not limited, on the non-smoothed sole bacteria spectrum.

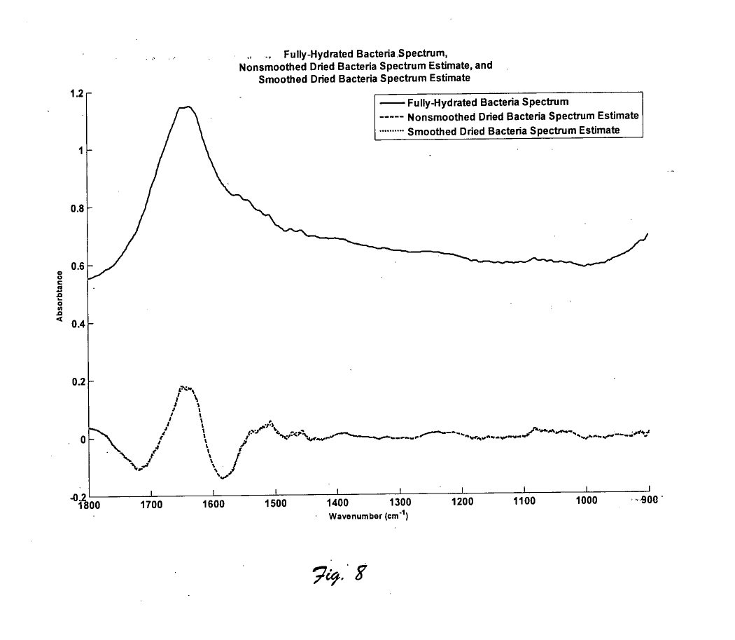

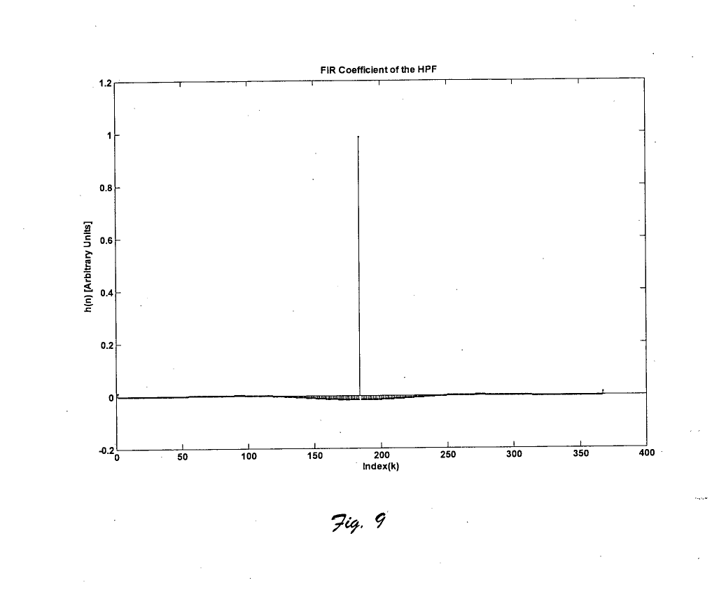

All the steps described above (in the third method) are illustrated in FIGS. 8-9.

FIG. 8 illustrates steps 1-4. FIG. 9 illustrates Finite-Impulse-Response (FIR) used to generate the HPF coefficients.

### Example 2

### Bacteria's Absorption Spectrum

Each type of bacteria has a unique spectral signature. Although many types of bacteria have similar spectral signatures there are still some spectral differences that are due to different proteins on the cell membrane and differences in the DNA/RNA structure. The following protocol was used to obtain the spectra signature of Meticylin Sensitive Staphylococcus Aurous (MSSA) and Meticylin Resistant Staphylococcus Aurous (MRSA):
1. A strip of 2 cm of MSSA and MRSA bacteria was removed from an agar plate (quadloop was used). Both the bacteria were purchased from HY labs and dissolve in two eppendorf tubes with 160 μl ddH2O each (Sigma-Aldrich W3500-100 mL):

| | ATCC Type | Cat number | Lot number | resistancy | signal |
|---|---|---|---|---|---|
| 1 | 6538 | 101692 | 7026 | MSSA | |
| 2 | 25923 | 101676 | 6985 | MSSA | |
| 3 | 43300 | 101709 | 7115 | MRSA | |

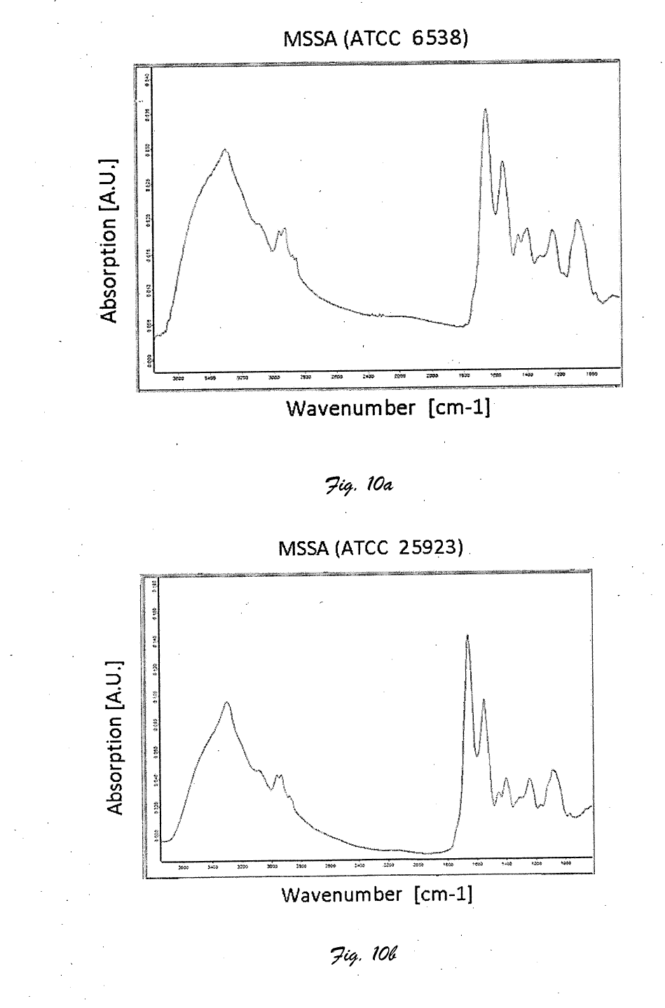

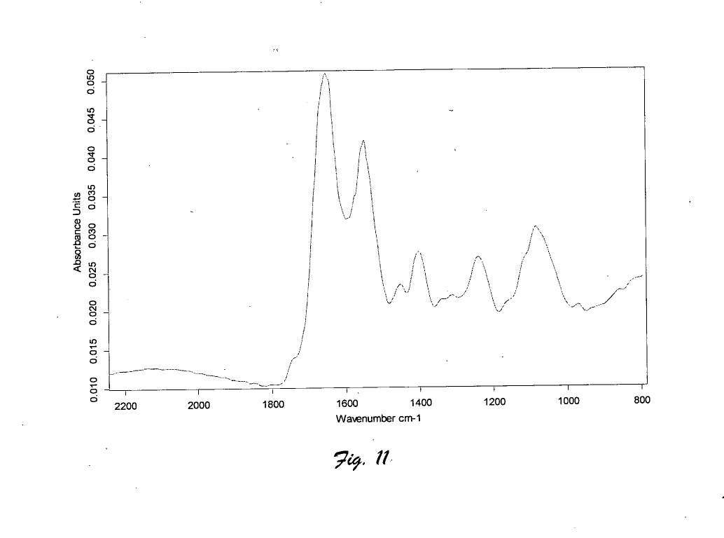

Each of species was introduced into 2 tubes, A and B, (i.e., total of 6 tubes, 3 A's and 3 B's).
1. Tube A for each of species was:
   a. centrifuge 7 minutes at 9000 RPM;
   b. discard supernatant;
   c. added with 1 mL ddH2O;
   d. centrifuge 7 minutes at 9000 RPM;
   e. discard supernatant;
   f. Added 160 mL;
2. Put 30 μL from tubes A and B in three areas on an optical plate (ZnSe). Each plate for a different subtype of Staph Aureus.
3. Place the plate in a desiccator (Dessicator 250 mm polypropylene) in the presence of several petri plates with a desiccant agent (Phosphorus Pentoxide cat #79610 Sigma Aldrich) and vacuum for 30 minutes.
4. Read and analyze the spectral signature.
   The following figures show the absorption spectrum of bacteria in the sample.
   Reference is now made to FIGS. 10a, 10b and 11 illustrating the absorption spectrum of Meticylin Sensitive Staphylococcus Aurous (MSSA) ATCC type 6538, and ATCC type 25923 and Meticylin Resistant Staphylococcus Aurous (MRSA) respectfully.

### Example 3

### Distinguishing Between Different Kind of Bacteria

The following examples illustrate in-vitro examples to provide a method to distinguish between different kinds of bacteria.

The identification and/or detection of specific bacteria were as follows:
(a) The water influence was eliminated using methods selected inter alia from, but not limited, low pass filter, high pass filter, and water absorption division to receive the dry bacteria spectrum estimate.
(b) the noise in each of the absorption spectra (without the water influence) was reduced by using Savitzky-Golay smoothing;
(c) m features such as, but not limited to, Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof were extracted from the spectra. A total of m features were extracted. m is an integer higher or equals 1;
(d) the signal was divided into several regions (segments, i.e., several wavenumber regions) according to said m features;
(e) m₁ features were extracted from at least one of the spectrum's regions. said m₁ features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; m₁ is an integer greater than or equal to one.
(f) the m features and the m₁ features were examined and checked whether they are within the n dimensional volume boundaries (which acquired by the statistical processing);
(g) the identification of the specific bacteria was determined as positive if the m features and/or the m₁ features are within the n dimensional volume boundaries.

Statistical Processing

The statistical processing is especially adapted to provide the n dimensional volume boundaries. For each specific bacterium the statistical processing was performed only once, for obtaining the boundaries. Once the boundaries were provided, the determination whether the specific bacteria is present in a sample was as explained above (i.e., verifying whether the feature vector are within the boundaries).

The statistical processing for each specific bacterium is performed in the following manner:
(a) obtaining several absorption spectrum (AS2) of known samples containing the specific bacteria;
(b) extracting x features from the signal such as, but not limited to, said x features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; x is an integer higher or equal to one A total of x features. x is an integer higher or equals 1;
(c) dividing the signal into several regions (segments) according to said x features;
(d) Calculating y features for at least one of the segments within the absorption spectrum; said y features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ,σ,Ai), different peaks' intensity ratios, wavelet coefficients or any combination thereof; y is an integer higher or equal to one;
(e) assigning at least one of said x features and/ or at least one of said y features to said specific bacteria;
(f) Defining n dimensional space n equals the sum of the x features and y features;
(g) Assigning and/or interlinking each one of the x and y features, to the specific bacteria which its identification is required;
(h) Optionally calculating the statistical distribution for each of the x and y features (thus, defining the n dimensional volume). and,
(i) Determining the boundaries of each volume by using a classifier or a combination of classifiers (for example k nearest neighbor, Bayesian classification et cetera).

It should be pointed out that the assignment of at least one of the x features and/or at least one of the y features to the specific bacteria is performed by method of feature selection and classification.

It should be further pointed out that the Gaussian distribution or Multivariate Gaussian distribution, or Rayleigh distribution, or Maxwell distribution, or Estimate the distribution by the Parzen method or mixed model (like the Gaussian Mixed Model known as GMM) for at least one of the n features such that the distributions defines the n dimensional volume in the n dimensional space.

It should be further emphasized that all the above mentioned steps could be performed on at least one of the o^{th} derivative of the absorption spectrum; o is an integer greater than or equals 1. e.g. the features are extracted from the o^{th} derivative instead of the signal.

If the features (extracted from the spectrum and/or its derivatives) are within the n dimensional volume boundaries, the specific bacteria is identified. Otherwise the bacteria are not identified.

Alternatively or additionally, each of the x and/or y features are given a weighting factor. The weighting factor is determined by the examining how each feature improves the bacteria detection prediction (for example by using maximum likelihood or Bayesian estimation). Once the weighting factor is assigned to each one of the x and y features the boundaries are determined for the features having the most significant contribution to the bacteria prediction.

Alternatively or additionally, the AS2 and its derivatives is smoothed by reducing the noise. The noise reduction is obtained by different smoothing techniques selected from a group consisting of running average savitzky-golay or any combination thereof.

Boundaries Calculation

As explained above, the boundaries are calculated according to the features which had the most significant contribution for the specific bacteria identification in the sample. The following figure is a 3D illustration of the two dimensional boundary based on the three best features from a segment of the spectrum.

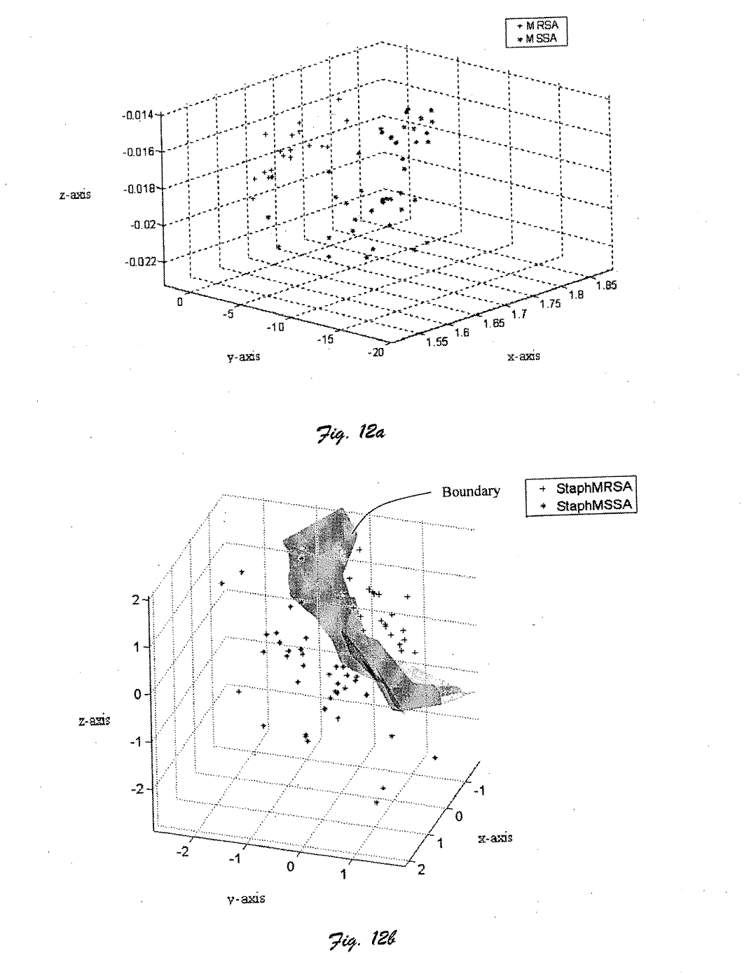

Reference is now made to FIG. 12a, which clearly enables to distinguish between the MRSA bacteria and MSSA bacteria. The diagram demonstrates the graphs after the water influence was eliminated using one of the above mentioned methods.

The values of the x-axis of FIG. 12a (or 12b) are calculated in the following manner:

A min-max normalization was employed on the first derivative of the dried-bacteria (i.e., bacteria spectrum after the water was eliminated) at 1091 cm⁻¹ wavenumber in the range [990-1170] wavenumber cm⁻¹.

The y-axis of FIG. 12a (or 12b) is coefficient #2 in the detail of the Wavelet transform at level 1 using the Daubechies family wavelet of order 2 on the min-max normalized dried-bacteria (i.e., bacteria spectrum after the water was eliminated) in the range [990 cm⁻-1170 cm⁻¹] wavenumber.

The z-axis of FIG. 12a (or 12b) is coefficient #21 in the detail of the Wavelet transform at level 2 using the Daubechies family wavelet of order 2 on the min-max normalized dried-bacteria estimate in the range [990 cm⁻¹-1170 cm⁻¹] wavenumber.

The m Features Extracted from the Spectrum

The following m features were extracted:

peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (μ, τ, Ai), different peaks' intensity ratios, wavelet coefficients or any combination thereof. m is an integer greater or equal to one.

The features were extracted from (i) the dried bacteria spectrum (i.e., after the water influence was eliminated), (ii) First derivative of the wet bacteria spectrum (prior to the water influence elimination), (iii) Second derivative of the wet bacteria spectrum, (iv) First derivative of the dried bacteria spectrum (i.e., after the water influence was eliminated), (v) Second derivative of the dried bacteria spectrum estimate (i.e., after the water influence was eliminated), (vi) Correlation.

Other features that were extracted were Peak's wave length and height of the wet bacteria spectrum, Peak's wave length and height of the dried bacteria spectrum estimate, Peak Width from a peak's wave length of the wet bacteria spectrum, Peak Width from a peak's wave length of the dried bacteria spectrum estimate, Peak Width from a specified wavenumber of the wet bacteria spectrum, Peak Width from a specified wavenumber of the dried bacteria spectrum estimate.

The m₁ features were extracted from at least one of the above mentioned spectrum segments.

The three most significant features found to be following:

1. The first derivative of the dried-bacteria (i.e., bacteria spectrum after the water was eliminated) at 1091 cm⁻¹ wavenumber in the range [990 cm⁻¹-1170 cm⁻¹] wavenumber after employing a min-max normalization on said first derivative.

2. coefficient #2 in the detail of the Wavelet transform at level 1 using the Daubechies family wavelet of order 2 on the min-max normalized dried-bacteria (i.e., bacteria spectrum after the water was eliminated) estimate in the range [990 - 1170] wavenumber cm⁻¹.

3. coefficient #21 in the detail of the Wavelet transform at level 2 using the Daubechies family wavelet of order 2 on the min-max normalized dried-bacteria estimate in the range [990 cm⁻¹-1170 cm⁻¹] wavenumber.

FIG. 12b is identical to FIG. 12a except for the fact that FIG. 12b also illustrates the boundaries between StaphMRSA and StaphMSSA.

FIG. 12a was constructed in the following manner:

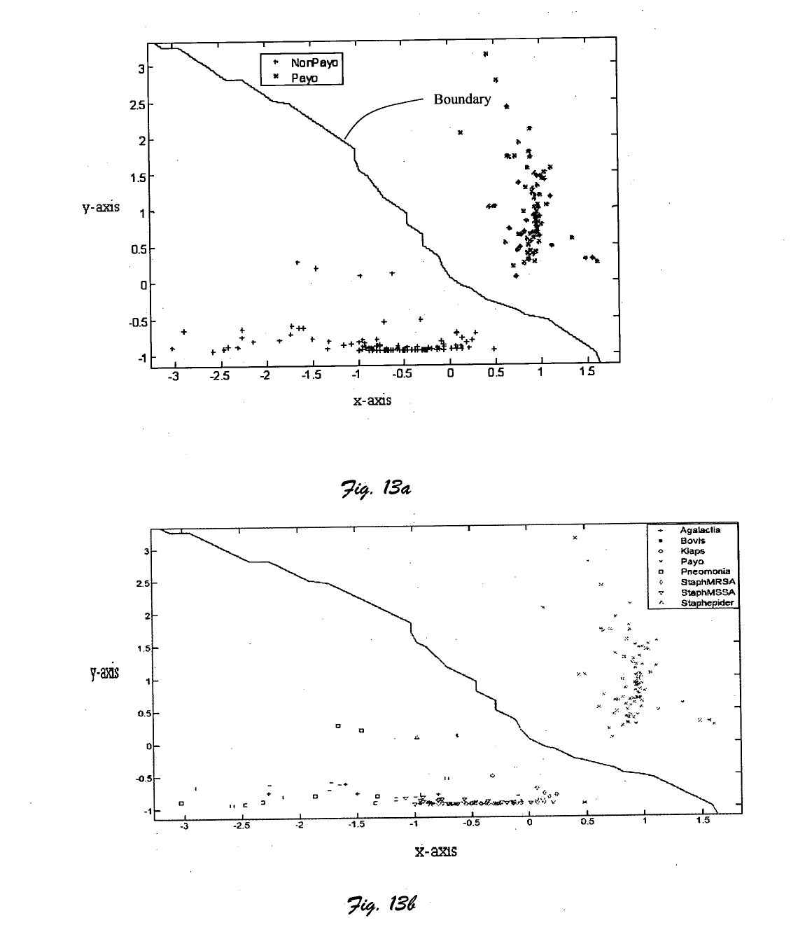

Step I—a separation between Streptococcus payogenes and other kinds of bacteria was conducted (see FIG. 13a and FIG. 13b). The other kind of bacteria consists of the following bacterium: Agalactia, Bovis, Klaps, Pneomonia, StaphMSSA, StaphMRSA, and Staphepider. The boundary between these classes is shown in the figure.

The values of the x-axis of FIGS. 13a and 13b are calculated in the following manner:

A min-max normalization was employed on the second derivative of the, dried-bacteria (i.e., bacteria spectrum after the water was eliminated) in the range [990 cm⁻¹-1170 cm⁻¹] wavenumber.

The values of the y-axis of FIGS. 13a and 13b are calculated in the following manner:

A min-max normalization was employed on the first derivative of the dried-bacteria (i.e., bacteria spectrum after the water was eliminated) at 1020 cm⁻¹ wavenumber in the range [990 cm⁻¹-1170 cm⁻¹] wavenumber.

FIG. 13b illustrates the different kinds of bacteria (e.g., Agalactia, Bovis, Klaps, Pneomonia, StaphMSSA, StaphMRSA, and Staphepider) that were included in the analysis.

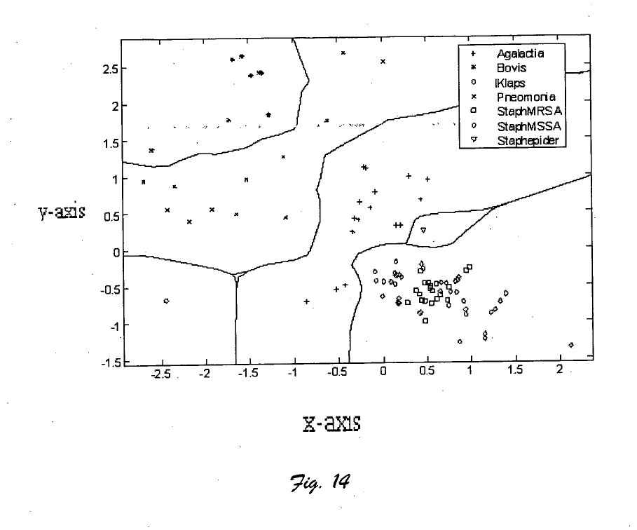

Step II—a separation in the Streptococcus payogenes classes between different species is conducted (see FIG. 14).

The values of the y-axis of FIG. 14 are coefficient #35 in the detail of the Wavelet transform at level 1 using the Daubechies family wavelet of order 2 on the min-max normalized dried-bacteria (i.e., bacteria spectrum after the water was eliminated) in the range [990 cm⁻¹-1170 cm⁻¹] wavenumber.

The values of the y-axis of FIG. 14 are coefficient #2 in the detail of the Wavelet transform at level 2 using the Daubechies family wavelet of order 2 on the min-max normalized dried-bacteria estimate in the range [990 cm¹-1170 cm¹] wavenumber.

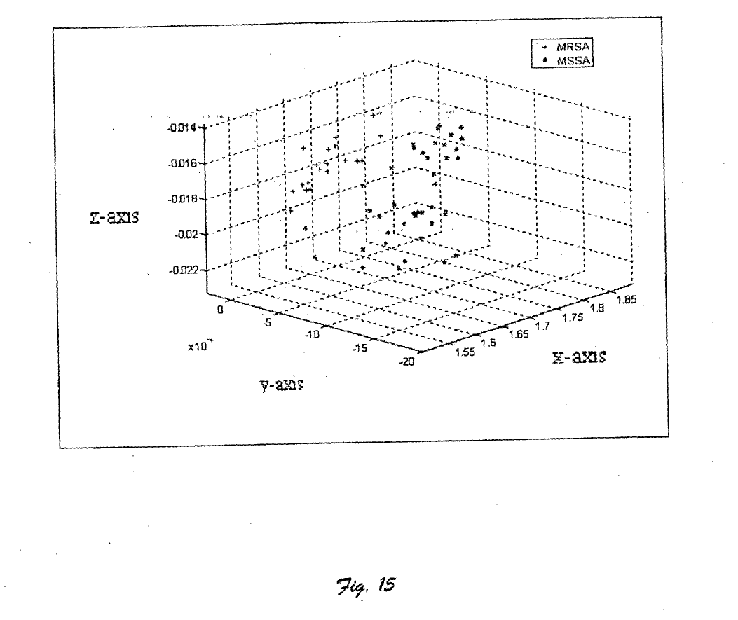

Step III—a separation between StaphMSSA and StaphMRSA species is conducted (see FIG. 15).

As described earlier, the values of the x-axis of FIG. 15 are calculated in the following manner:

A min-max normalization was employed on the first derivative of the dried-bacteria (i.e., bacteria spectrum after the water was eliminated) at 1091 cm⁻¹ wavenumber in the range [990-1170] wavenumber cm⁻¹.

The y-axis of FIG. 15 is coefficient #2 in the detail of the Wavelet transform at level 1 using the Daubechies family wavelet of order 2 on the min-max normalized dried-bacteria (i.e., bacteria spectrum after the water was eliminated) in the range [990 cm⁻¹-1170 cm⁻¹] wavenumber.

The z-axis of FIG. 15 is coefficient #21 in the detail of the Wavelet transform at level 2 using the Daubechies family wavelet of order 2 on the min-max normalized dried-bacteria estimate in the range [990 cm⁻¹-1170 cm⁻¹] wavenumber.

### Example 4

### Distinguishing between MRSA and MSSA

The following example demonstrates that a distinction can be made between MRSA and MSSA.

The system was tested using 74 samples of MSSA and 91 samples of MRSA.

The calculated sensitivity and specificity are 98.66% and 100% respectively.

Experimental Protocol
1. A strips of bacteria is removed from the agar plate (via a quadloop) and the same us dissolved in an eppendorf tube with 400 μl ddH2O (Sigma-Aldrich W3500-100 mL).
2. 30 μL from every tube is put on an area on an optical plate (ZnSe).
3. The plate is placed in a desiccator (Dessicator 250 mm polypropylene, Yavin Yeda) in the presence of several petri plates with a desiccant agent (Phosphorus Pentoxide cat #79610 Sigma Aldrich) and vacuum is used for 30 minutes.
4. The spectral signature is read:
5. The spectral analysis is performed. The analysis provides the differentiation between the resistant and sensitive bacteria.

It should be pointed out that the same experimental protocol was performed to each of the following bacteria.

VRE (Vancomycin Resistant Enterococcus) Vs. VSE (Vancomycin Resistant Enterococcus)

Enterococcus Faecium Sensitive to Vancomycin vs. Enterococcus Faecium Resistant to Vancomycin

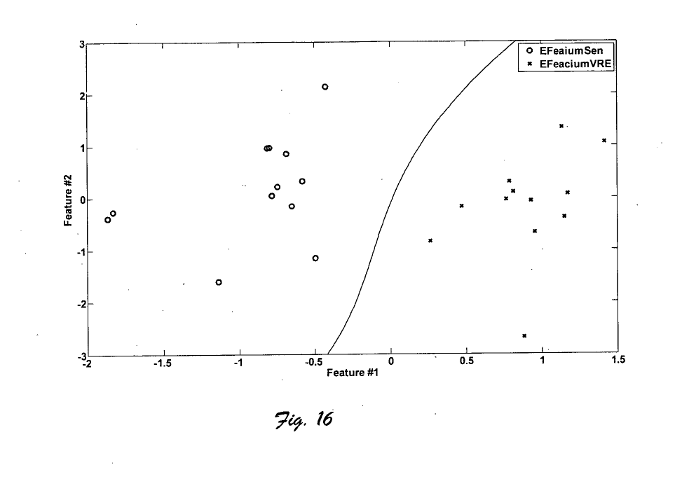

Reference is now made to FIG. 16 which illustrates the differentiation between Enterococcus Faecium sensitive to Vancomycin and Enterococcus Faecium Resistant to Vancomycin.

In the graph, the x-axis represents Feature #1 which is the value at 1045.8559 cm⁻¹ of the max normalized absorbance signal in the region [942 1187] cm⁻¹ after its baseline was subtracted.

The Y-axis represents Feature #2 which is the value at 943.9871 cm⁻¹ of the max normalized absorbance signal in the region [942 1187] cm⁻¹ after its baseline was subtracted.

As is clear from the figure, the Enterococcus Faecium sensitive to Vancomycin and Enterococcus Faecium Resistant to Vancomycin can be identified individually.

Enterococcus Faecalis Sensitive to Vancomycin vs. Enterococcus Faecalis Resistant to Vancomycin

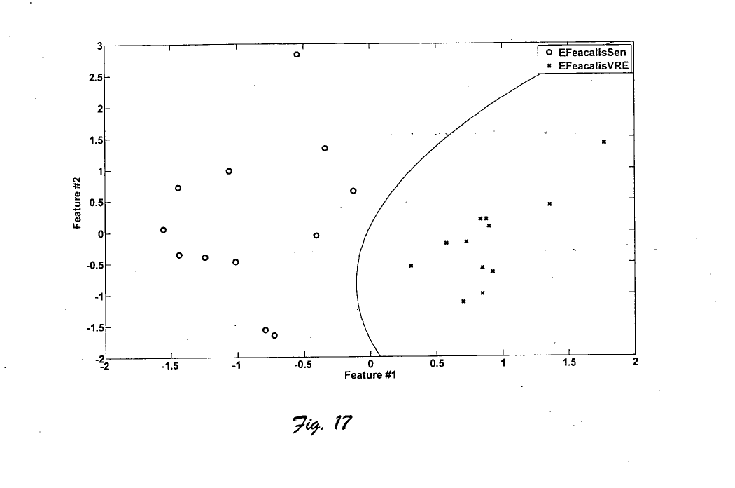

Reference is now made to FIG. 17 which illustrates the differentiation between Enterococcus Faecalis_sensitive to Vancomycin and Enterococcus Faecalis_Resistant to Vancomycin.

In the graph, the x-axis represents Feature #1 which is the value at 1177.8319 cm⁻¹ of the max normalized signal in the region [942 1187] cm⁻¹ after its baseline was subtracted.

The Y-axis represents Feature #2 which is the value at 945.4642 cm⁻¹ of the min-max normalized of the 2^{nd} derivate in the region [942 1187] cm⁻¹, where the derivative was calculated on the max normalized absorbance signal in the region [942 1187] cm⁻¹ after its baseline was subtracted.

As is clear from the figure, the Enterococcus faecalis_sensitive to Vancomycin and Enterococcus faecalis_Resistant to Vancomycin can be identified individually.

Acinetobacter Senesitive to Antibiotics vs. Acinetobacter Resistant to Antibiotics

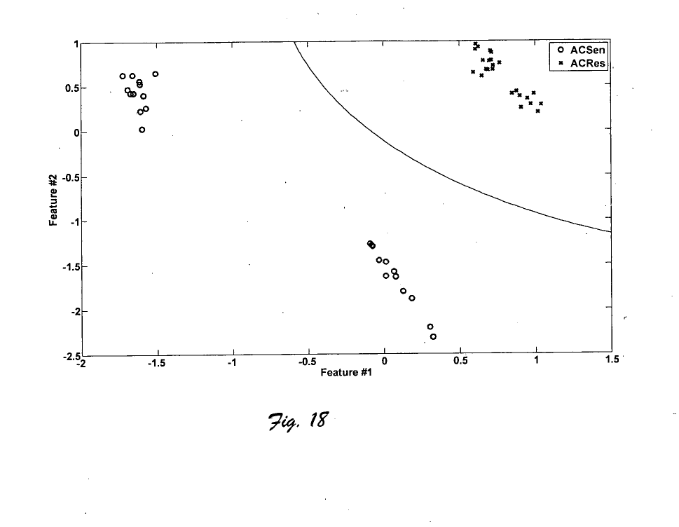

Reference is now made to FIG. 18 which illustrates the differentiation between Acinetobacter sensitive to antibiotic and Acinetobacter Resistant to antibiotics.

In the graph, the x-axis represents Feature #1 which is the value at 1172.0934 cm⁻¹ of the max normalized absorbance signal in the region [942 1187] cm⁻¹ after its baseline was subtracted.

The Y-axis represents Feature #2 which is the value at 1021.4572 cm⁻¹ of the min-max normalized of the 2^{nd} derivate in the region [942 1187] cm⁻¹, where the derivative was calculated on the max normalized absorbance signal in the region [942 1187] cm⁻¹ after its baseline was subtracted.

As is clear from the figure, the Acinetobacter sensitive to antibiotic and Acinetobabter Resistant to antibiotics can be identified individually.

Klebsiella Pneumonia (KP)

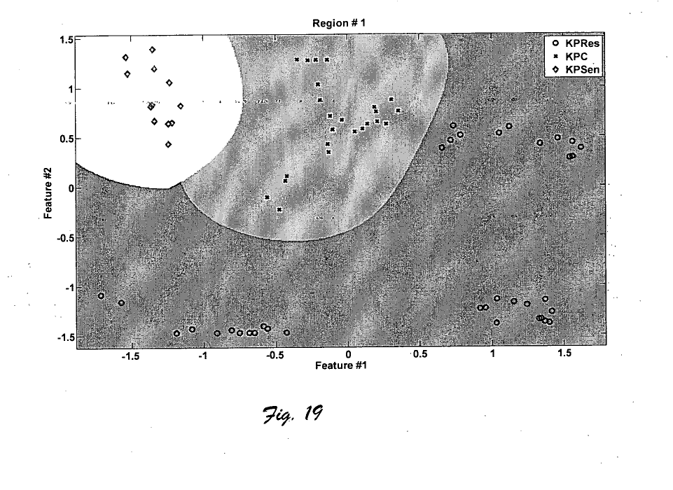

Reference is now made to FIG. 19 illustrating the differentiation between KP Sen (i.e, sensitive to antibiotics), KP Res (resistant to antibiotics) and KPC (Resistant to carbapenem (more resistant then the previous type)).

In the graph, the x-axis represents Feature #1 which is the value at 1163.4856 cm⁻¹ of the min-max normalized of the 1^{st} derivate in the region [942 1187] cm⁻¹, where the derivative was calculated on the max normalized absorbance signal in the region [942 1187] cm⁻¹ after its baseline was subtracted.

The Y-axis represents Feature #2 which is the value at 1024.3264 cm⁻¹ of the min-max normalized of the 2^{nd} derivates in the region [942 1187] cm⁻¹, where the derivative was calculated on the max normalized absorbance signal in the region [942 1187] cm⁻¹ after its baseline was subtracted.

As is clear from the figure, the KP Sen, KP Res or the KPC can be identified individually.

BloodMSSA vs. BloodMRSA

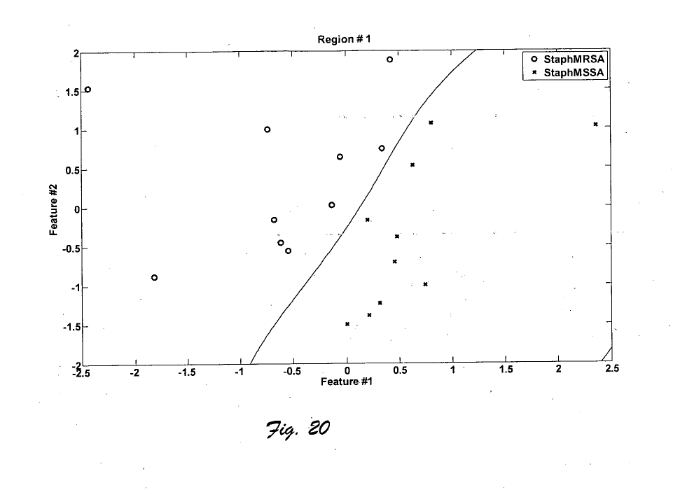

Reference is now made to FIG. 20 illustrating the differentiation between samples of blood with MRSA and MSSA.

In the graph, the x-axis represents Feature #1 which is the value at 1094.6233 cm⁻¹ of the min-max normalized of the 2^{nd} derivate in the region [925 1190] cm⁻¹, where the derivative was calculated on the max normalized absorbance signal in the region [925 1190] cm⁻¹ after its baseline was subtracted.

The Y-axis represents Feature #2 which is the value at 1070.2346 cm⁻¹ of the min-max normalized of the 1^{st} derivate in the region [925 1190] cm⁻¹, where the derivative was calculated on the max normalized absorbance signal in the region [925 1190] cm⁻¹ after its baseline was subtracted.

As is clear from the figure, the blood samples containing MRSA and/or MSSA can be identified individually.

Swab Samples

Experimental Protocol for the Swabbing Experiments
1. A Copan cotton swab is used to pick up human fluid sample in duplicates.
   a. Swab #1—human fluid without bacteria.
   b. Swab #2—pick up 1-5 CFUs from a MRSA or MSSA plate.
2. Do reference reading of the optical cell.
3. Apply each of the swabs on the optical cell.
4. Read the spectral signature
5. Analyze the recorded data

NoseMSSA vs. NoseMRSA

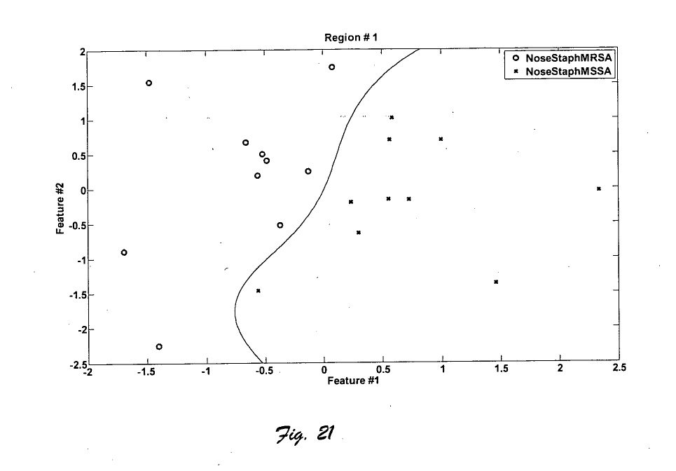

Reference is now made to FIG. 21 illustrating the differentiation between nose swabs samples spiked with MRSA and MSSA.

In the graph, the x-axis represents Feature #1 which is the value at 1065.9307 cm⁻¹ of the min-max normalized of the 2^{nd} derivate in the region [925 1190] cm⁻¹, where the derivative was calculated on the max normalized absorbance signal in the region [925 1190] cm⁻¹ after its baseline was subtracted.

The Y-axis represents Feature #2 which is the value at 974.1144 cm⁻¹ of the min-max normalized of the 2^{nd} derivate in the region [925 1190] cm⁻¹, where the derivative was calculated on the max normalized absorbance signal in the region [925 1190] cm⁻¹ after its baseline was subtracted.

As is clear from the figure, the nose swabs samples spiked with MRSA and/or MSSA can be identified individually.

AxillaryMSSA vs. AxillaryMRSA

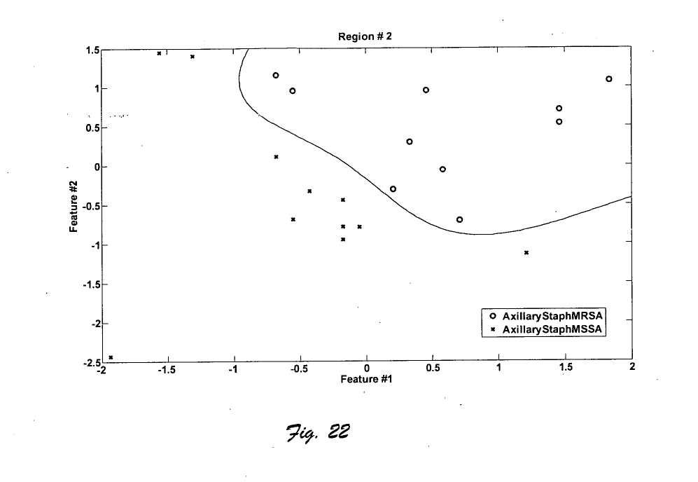

Reference is now made to FIG. 22 illustrating the differentiation between axillary swabs spiked with MRSA and MSSA.

In the graph, the x-axis represents Feature #1 which is the width of the peak measured from 1650 cm⁻¹ to the half of its magnitude of the value at 1650 cm⁻¹ in the max normalized signal in the region [1458 1800] cm⁻¹ after its baseline was subtracted. The Y-axis represents Feature #2 which is the cD1(95)—coefficient #95 in the approximation of level #1 with db2 wavelet transform, where db2 is the Daubechies family wavelet of order 2. The transformation was applied on the max normalized signal in the region [1458 1800] cm⁻¹ after its baseline was subtracted.

As is clear from the figure, the axillary swabs spiked with MRSA and/or MSSA can be identified individually.

1. A method for detecting and/or identifying specific bacteria within an uncultured sample; said method comprising steps of:
a. obtaining an absorption spectrum (AS) of said uncultured sample;
b. acquiring the n dimensional volume boundaries for said specific bacteria by
i. obtaining at least one absorption spectrum (AS2) of known samples containing said specific bacteria;
ii. extracting x features from said entire AS2; said x features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (m,s,Ai), different peaks' intensity ratios, wavelet coefficients or any combination thereof; x is an integer higher or equal to one; x is an integer greater than or equal to one;
iii. dividing said AS2 into several segments according to said x features;
iv. calculating y features of each of said segment of said AS2; said y features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (m,s,Ai), different peaks' intensity ratios, wavelet coefficients or any combination thereof; y is an integer higher or equal to one;
v. assigning at least one of said x features and/ or at least one of said y features to said specific bacteria by algorithms selected from a group consisting of Sequential Backward Selection, Sequential Forward Selection, Sequential Forward Floating Selection (SFFS), Max-Min algorithm, trace(S_{b})/trace(S_{w}); S_{w}/(S_{b}+S_{w}); Kullback-Lieber divergence; correct classification rate; and any combination thereof;
vi. defining n dimensional space; n equals the sum of said x and said y features;
vii. defining the n dimensional volume in said n dimensional space;
viii. determining said boundaries of said n dimensional volume by using technique selected from a group consisting of Bayes classifier, Support Vector Machine (SVM), Linear discriminant, functions and Fisher's linear discriminant, C4.5 algorithm tree, K-nearest neighbor, Gaussian Mixed Model (GMM), Weighted K-nearest neighbor, Hierarchical clustering algorithm, K-mean clustering algorithm, Ward's clustering algorithm, Minimum least square, Neural-Network or any combination thereof;
c. data processing said AS;
i. noise reducing by using different smoothing techniques selected from a group consisting of running average savitzky-golay, low pass filter or any combination thereof;
ii. extracting m features from said entire AS; said m features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (m,s,Ai), different peaks' intensity ratios, wavelet coefficients or any combination thereof; m is an integer higher or equal to one;
iii. dividing said AS into several segments according to said m features;
iv. calculating m₁ features of each of said segment; said m₁ features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (m,s,Ai), different peaks' intensity ratios, wavelet coefficients or any combination thereof; m₁ is an integer greater than or equal to one; and,
d. detecting and/or identifying said specific bacteria if said m₁ features and/or said m features are within said n dimensional volume;
wherein said bacteria is a antibiotics resistance bacteria.

2. The method for detecting and/or identifying specific bacteria within an uncultured sample according to claim 1, additionally comprising step of selecting said x feature and/or said y features via algorithms selected form Chi-Squared, c2, test, Wilcoxon test, and t-test or any combination thereof

3. The method for detecting and/or identifying specific bacteria within an uncultured sample according to claim 1, wherein said sample is an aerosol or solid or liquid sample selected from a group consisting of cough, sneeze, saliva, mucus, bile, urine, vaginal secretions, middle ear aspirate, pus, pleural effusions, synovial fluid, abscesses, cavity swabs, serum, blood and spinal fluid.

4. The method for detecting and/or identifying specific bacteria within an uncultured sample according to claim 1, wherein said step of acquiring the n dimensional volume boundaries for the specific bacteria, additionally comprising step of calculating the Gaussian distribution and/or Multivariate Gaussian distribution, and/or Rayleigh distribution, and/or Maxwell distribution, and/or Estimate the distribution by the Parzen method or mixed model (like the Gaussian Mixed Model known as GMM) for at least one of the n features such that the distributions defines the n dimensional volume in the n dimensional space.

5. The method for detecting and/or identifying specific bacteria within an uncultured sample according to claim 1, wherein said step (c) of data processing said AS additionally comprising steps of:
i. calculating at least one of the o^{th} derivative of said AS; said o is an integer greater than or equals 1;
ii. extracting m₂ features from said entire o^{th} derivative spectrum; said m₂ features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (m,s,Ai), different peaks' intensity ratios, wavelet coefficients or any combination thereof; m₂ is an integer greater than or equal to one;
iii. dividing said o^{th} derivative into several segments according to said m₂ features;
iv. calculating the m₃ features in at least one of said segments; said m₃ features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (m,s,Ai), different peaks' intensity ratios, wavelet coefficients or any combination thereof; m₂ is an integer greater than or equal to one; and,
v. detecting and/or identifying said specific bacteria if said m₁ and/or m₃ features and/or said m and/or said m₂ features are within said n dimensional volume.

6. The method for detecting and/or identifying specific bacteria within an uncultured sample according to claim 1, additionally comprising the step of selecting said specific bacteria from a is selected from a group consisting of Gram negative pathogens such as Various types of Acinetobacter (for example: A. baumannii), Stenotrophomonas maltophilia, Gram positive pathogens such as Streptococcus pneumonia resistant to b lactamase and macrolides, Streptococcus viridians group resistant to b lactamase and aminoglycosides, enterococci resistant to vancomycin and teicoplanin and highly resistant to penicillins and aminoglycosides (for example: Enterococcus Faecium, Enterococcus Faecalis), staphylococcus aureus, B lactams, macrolides, lincosamides and aminoglicozides. Streptococcus pyogenes resistant to macrolides, macrolide-resistant streptococci of groups B, C and G. Coagulase negative staphylococci resistant to b lactams, aminoglycosides, macrolides, lincosamides and glycopeptides, multiresistant strains of Listeria and corynebacterium, Peptostreptococcus and clostridium, C. Difficile, Haemophilus Influenza resistant to b lactamase, Pseudomonas Aeruginosa, Stenotrophomonas Maltophilia, Klebsiella Pneumonia resistant to antibiotics Klebsiella Pneumonia, Klebsiella Pneumonia sensitive to antibiotics, aminoglycosides and macrolides or any combination thereof.

7. The method for detecting and/or identifying specific bacteria within an uncultured sample according to claim 1, wherein said step of obtaining the AS additionally comprising steps of:
a. providing at least one optical cell accommodates said uncultured sample;
b. providing p light source selected from a group consisting of laser, lamp, LEDs tunable lasers, monochrimator, p is an integer equal or greater than 1; said p light source are adapted to emit light to said optical cell;
c. providing detecting means for receiving the spectroscopic data of said sample;
d. emitting light from said light source at different wavelength to said optical cell; and,
e. collecting said light exiting from said optical cell by said detecting means; thereby obtaining said AS.

8. The method for detecting and/or identifying specific bacteria within an uncultured sample according to claim 7, wherein said step of emitting light is performed at the wavelength range of UV, visible, IR, mid-IR, far-IR and terahertz.

9. A method for detecting and/or identifying specific bacteria within an uncultured sample; said method comprising steps of:
a. obtaining an absorption spectrum (AS) of said uncultured sample; said AS containing water influence;
b. acquiring the n dimensional volume boundaries for said specific bacteria by:
i. obtaining at least one absorption spectrum (AS2) of known samples containing said specific bacteria;
ii. extracting x features from said AS2; said x features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (m,s,Ai), different peaks' intensity ratios, wavelet coefficients or any combination thereof; x is an integer higher or equal to one; x is an integer greater than or equal to one;
iii. calculating at least one derivative of said AS2;
iv. dividing said AS2 into several segments according to said x features;
v. calculating the y features of each of said segment; said y features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (m,s,Ai), different peaks' intensity ratios, wavelet coefficients or any combination thereof; y is an integer higher or equal to one;
vi. assigning at least one of said x features and/ or at least one of said y features to said specific bacteria by algorithms selected from a group consisting of Sequential Backward Selection, Sequential Forward Selection, Sequential Forward Floating Selection (SFFS), Max-Min algorithm, trace(S_{b})/trace(S_{w}); S_{w}/(S_{b}+S_{w}); Kullback-Lieber divergence; correct classification rate; and any combination thereof;
vii. defining n dimensional space; n equals the sum of said x features and said y features;
viii. defining the n dimensional volume in said n dimensional space;
ix. determining said boundaries of said n dimensional volume by using technique selected from a group consisting of Bayes classifier, Support Vector Machine (SVM), Linear discriminant, functions and Fisher's linear discriminant, C4.5 algorithm tree, K-nearest neighbor, Weighted K-nearest neighbor, Hierarchical clustering algorithm, Gaussian Mixed Model (GMM), K-mean clustering algorithm, Ward's clustering algorithm, Minimum least square, Neural-Network or any combination thereof;
c. eliminating said water influence from said AS by at least one of the following methods: Low pass filter, High pass filter and Water absorption division;
d. data processing said AS without said water influence by
i. noise reducing by using different smoothing techniques selected from a group consisting of running average savitzky-golay, low pass filter or any combination thereof;
ii. extracting m features from said entire AS; said m features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (m,s,Ai), different peaks' intensity ratios, wavelet coefficients or any combination thereof; m is an integer greater or equal to one;
iii. dividing said AS into several segments according to said m features;
iv. calculating the m₁ features of at least one of said segment; said m₁ features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (m,s,Ai), different peaks' intensity ratios, wavelet coefficients or any combination thereof; m₁ is an integer greater than or equal to one; and,
e. detecting and/or identifying said specific bacteria if said m₁ features and/or said m features are within said n dimensional volume;
wherein said bacteria is a antibiotics resistance bacteria.

10. The method for detecting and/or identifying specific bacteria within an uncultured sample according to claim 9, additionally comprising step of selecting said x feature and/or said y features via algorithms selected form Chi-Squared, c2, test, Wilcoxon test, and t-test or any combination thereof

11. The method for detecting and/or identifying specific bacteria within an uncultured sample according to claim 9, wherein said sample is an aerosol or solid or liquid sample selected from a group consisting of cough, sneeze, saliva, mucus, bile, urine, vaginal secretions, middle ear aspirate, pus, pleural effusions, synovial fluid, abscesses, cavity swabs, serum, blood and spinal fluid.

12. The method for detecting and/or identifying specific bacteria within an uncultured sample according to claim 9, wherein said step of acquiring the n dimensional volume boundaries for the specific bacteria, additionally comprising step of calculating the Gaussian distribution and/or Multivariate Gaussian distribution, and/or Rayleigh distribution, and/or Maxwell distribution, and/or Estimate the distribution by the Parzen method or mixed model (like the Gaussian Mixed Model known as GMM) for at least one of the n features such that the distributions defines the n dimensional volume in the n dimensional space.

13. The method for detecting and/or identifying specific bacteria within an uncultured sample according to claim 9, wherein said step (c) of data processing said AS without said water influence, additionally comprising steps of
i. calculating at least one of the o^{th} derivative of said AS; said o is an integer greater than or equals 1;
ii. extracting m₂ features from said entire o^{th} derivative spectrum; said m₂ features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (m,s,Ai), different peaks' intensity ratios, wavelet coefficients or any combination thereof; m₂ is an integer greater than or equal to one;
iii. dividing said o^{th} derivative into several segments according to said m₂ features;
iv. calculating the m₃ features in at least one of said segments; said m₃ features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (m,s,Ai), different peaks' intensity ratios, wavelet coefficients or any combination thereof; m₂ is an integer greater than or equal to one; and,
v. detecting and/or identifying said specific bacteria if said m₁ and/or m₃ features and/or said m and/or said m₂ features are within said n dimensional volume.

14. The method for detecting and/or identifying specific bacteria within an uncultured sample according to claim 9, additionally comprising the step of selecting said specific bacteria selected from a is selected from a group consisting of Gram negative pathogens such as Various types of Acinetobacter A. baumannii, Stenotrophomonas maltophilia, Gram positive pathogens such as Streptococcus pneumonia resistant to b lactamase and macrolides, Streptococcus viridians group resistant to b lactamase and aminoglycosides, enterococci resistant to vancomycin and teicoplanin and highly resistant to penicillins and aminoglycosides (for example: Enterococcus Faecium, Enterococcus Faecalis, staphylococcus aureus B lactams, macrolides, lincosamides and aminoglicozides. Streptococcus pyogenes resistant to macrolides, macrolide-resistant streptococci of groups B, C and G. Coagulase negative staphylococci resistant to b lactams, aminoglycosides, macrolides, lincosamides and glycopeptides, multiresistant strains of Listeria and corynebacterium, Peptostreptococcus and clostridium C. Difficile, resistant to penicillins and macrolides, Haemophilus Influenza resistant to b lactamase, Pseudomonas Aeruginosa, Stenotrophomonas Maltophilia, Klebsiella Pneumonia resistant to antibiotics Klebsiella Pneumonia Resistant to carbapenem), Klebsiella Pneumonia sensitive to antibiotics, aminoglycosides and macrolides or any combination thereof.

15. The method for detecting and/or identifying specific bacteria within an uncultured sample according to claim 9, wherein said step of obtaining the AS additionally comprising steps of:
a. providing at least one optical cell accommodating said uncultured sample;
b. providing p light source selected from a group consisting of laser, lamp, LEDs tunable lasers, monochrimator, p is an integer equal or greater than 1; said p light source are adapted to emit light to said optical cell;
c. providing detecting means for receiving the spectroscopic data of said sample;
d. emitting light from said light source at different wavelength to said optical cell;
e. collecting said light exiting from said optical cell by said detecting means; thereby obtaining said AS.

16. The method for detecting and/or identifying specific bacteria within an uncultured sample according to claim 15, wherein said step of emitting light is performed at the wavelength range of UV, visible, IR, mid-IR, far IR and terahertz.

17. The method for detecting and/or identifying specific bacteria within an uncultured sample according to claim 1, wherein the absorption spectra is obtained using an instrument selected from the group consisting of a spectrometer, Fourier transform infrared spectrometer, a fluorometer and a Raman spectrometer.

18. The method for detecting and/or identifying specific bacteria within an uncultured sample according to claim 1, wherein said sample is taken from the human body.

19. A system 1000 adapted to detect and/or identify specific bacteria within an uncultured sample; said system comprising:
a. means 100 for obtaining an absorption spectrum (AS) of said uncultured sample;
b. statistical processing means 200 for acquiring the n dimensional volume boundaries for said specific bacteria; said means 200 are characterized by:
i. means 201 for obtaining at least one absorption spectrum (AS2) of known samples containing said specific bacteria;
ii. means 202 for extracting x features from said entire AS2; said x features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (m,s,Ai), different peaks' intensity ratios, wavelet coefficients or any combination thereof; x is an integer higher or equal to one;
iii. means 203 for dividing said AS2 into several segments according to said x features;
iv. means 204 for calculating y features from at least one of each of said segment; said y features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (m,s,Ai), different peaks' intensity ratios, wavelet coefficients or any combination thereof; y is an integer higher or equal to one;
v. means 205 for assigning at least one of said x features and/ or at least one of said y features to said specific bacteria by algorithms selected from a group consisting of Sequential Backward Selection, Sequential Forward Selection, Sequential Forward Floating Selection (SFFS), Max-Min algorithm, trace(S_{b})/trace(S_{w}); S_{w}/(S_{b}+S_{w}); Kullback-Lieber divergence; correct classification rate; and any combination thereof;
vi. means 206 for defining n dimensional space; n equals the sum of said x features and said y features;
i. means 207 for defining the n dimensional volume in the n dimensional space;
vii. means 208 for determining said boundaries of said n dimensional volume by using technique selected from a group consisting of Bayes classifier, Support Vector Machine (SVM), Linear discriminant, functions and Fisher's linear discriminant, C4.5 algorithm tree, K-nearest neighbor, Weighted K-nearest neighbor, Hierarchical clustering algorithm, Gaussian Mixed Model (GMM), K-mean clustering algorithm, Ward's clustering algorithm, Minimum least square, Neural-Network or any combination thereof;
viii. means 209 for assigning the n dimensional volume to said specific bacteria;
c. means 300 for data processing said AS; said means 300 are characterized by
i. means 301 for noise reducing by using different smoothing techniques selected from a group consisting of running average savitzky-golay, low pass filter or any combination thereof;
ii. means 302 for extracting m features from said entire AS; said m features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (m,s,Ai), different peaks' intensity ratios, wavelet coefficients or any combination thereof; m is an integer higher or equal to one;
iii. means 303 for dividing said AS into several segments according to said m features;
iv. means 304 for calculating the m₁ features of at least one of said segment; said m₁ features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (m,s,Ai), different peaks' intensity ratios, wavelet coefficients or any combination thereof; m₁ is an integer greater than or equal to one; and,
d. means 400 for detecting and/or identifying said specific bacteria if said m₁ features and/or said m features are within said n dimensional volume;
wherein said bacteria is an antibiotics resistance bacteria.

20. The system 1000 according to claim 19, additionally comprising means for selecting said x feature and/or said y features via algorithms selected form Chi-Squared, c2, test, Wilcoxon test, and t-test or any combination thereof.

21. The system 1000 according to claim 19, wherein said sample is an aerosol or solid or liquid sample selected from a group consisting of cough, sneeze, saliva, mucus, bile, urine, vaginal secretions, middle ear aspirate, pus, pleural effusions, synovial fluid, abscesses, cavity swabs, serum, blood and spinal fluid.

22. The system 1000 according to claim 19, wherein said statistical processing means 200 additionally comprising means 210 for calculating the Gaussian distribution or Multivariate Gaussian distribution, or Rayleigh distribution, or Maxwell distribution, or Estimate the distribution by the Parzen method or by mixed model (like the Gaussian Mixed Model known as GMM) for at least one of the n features such that the distributions defines the n dimensional volume in the n dimensional space.

23. The system 1000 according to claim 19, wherein said means 300 for data processing said AS additionally characterized by:
i. means 305 for calculating at least one of the o^{th} derivative of said AS; said o is an integer greater than or equals 1;
ii. means 306 for extracting m₂ features from said entire o^{th} derivative spectrum; said m₂ features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (m,s,Ai), different peaks' intensity ratios, wavelet coefficients or any combination thereof; m₂ is an integer greater than or equal to one;
iii. means 307 for dividing said o^{th} derivative into several segments according to said m₂ features;
iv. means 308 for calculating the m₃ features in at least one of said segments; said m₃ features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (m,s,Ai), different peaks' intensity ratios, wavelet coefficients or any combination thereof; m₂ is an integer greater than or equal to one; and,
v. Means 309 for detecting and/or identifying said specific bacteria if said m₁ and/or m₃ features and/or said m and/or said m₂ features are within said n dimensional volume.

24. The system 1000 according to claim 19, wherein said specific bacteria is selected from a is selected from a group consisting of Gram negative pathogens such as Various types of Acinetobacter A. baumannii, Stenotrophomonas maltophilia, Gram positive pathogens such as Streptococcus pneumonia resistant to b lactamase and macrolides, Streptococcus viridians group resistant to b lactamase and aminoglycosides, enterococci resistant to vancomycin and teicoplanin and highly resistant to penicillins and aminoglycosides (for example: Enterococcus Faecium, Enterococcus Faecalis), staphylococcus aureus, B lactams, macrolides, lincosamides and aminoglicozides. Streptococcus pyogenes resistant to macrolides, macrolide- resistant streptococci of groups B, C and G. Coagulase negative staphylococci resistant to b lactams, aminoglycosides, macrolides, lincosamides and glycopeptides, multiresistant strains of Listeria and corynebacterium, Peptostreptococcus and clostridium, C. Difficile, Haemophilus Influenza resistant to b lactamase, Pseudomonas Aeruginosa, Stenotrophomonas Maltophilia, Klebsiella Pneumonia resistant to antibiotics, Klebsiella Pneumonia Resistant to carbapenem Klebsiella Pneumonia sensitive to antibiotics, aminoglycosides and macrolides or any combination thereof.

25. The system 1000 according to claim 19, wherein said means 100 for obtaining an absorption spectrum (AS) of said sample additionally comprising:
a. at least one optical cell for accommodating said uncultured sample;
b. p light source selected from a group consisting of laser, lamp, LEDs tunable lasers, monochrimator, p is an integer equal or greater than 1; said p light source are adapted to emit light at different wavelength to said optical cell; and,
c. Detecting means for receiving the spectroscopic data of said sample exiting from said optical cell.

26. The system 1000 according to claim 25, wherein said p light source are adapted to emit light at wavelength range selected from a group consisting of UV, visible, IR, mid-IR, far-IR and terahertz.

27. A system 2000 adapted to detect and/or identify specific bacteria within an uncultured sample; said system 2000 comprising:
a. means 100 for obtaining an absorption spectrum (AS) of said uncultured sample; said AS containing water influence;
b. statistical processing means 200 for acquiring the n dimensional volume boundaries for said specific bacteria; said means 200 are characterized by:
i. means 201 for obtaining at least one absorption spectrum (AS2) of known samples containing said specific bacteria;
ii. means 202 for extracting x features from said entire AS2; said x features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (m,s,Ai), different peaks' intensity ratios, wavelet coefficients or any combination thereof; x is an integer higher or equal to one; x is an integer greater than or equal to one;
iii. means 203 for dividing said AS2 into several segments according to said x features;
iv. means 204 for calculating the y features of at least one of said segments; said y features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (m,s,Ai), different peaks' intensity ratios, wavelet coefficients or any combination thereof; y is an integer higher or equal to one;
v. means 205 for assigning at least one of said x features and/ or at least one of said y features to said specific bacteria by algorithms selected from a group consisting of Sequential Backward Selection, Sequential Forward Selection, Sequential Forward Floating Selection (SFFS), Max-Min algorithm, trace(S_{b})/trace(S_{w}); S_{w}/(S_{b}+S_{w}); Kullback-Lieber divergence; correct classification rate; and any combination thereof;
vi. means 206 for defining n dimensional space; n equals the sum of said x features and said y features;
vii. means 207 for defining the n dimensional volume in said n dimensional space;
viii. means 208 for determining said boundaries of said n dimensional volume by using technique selected from a group consisting of Bayes classifier, Support Vector Machine (SVM), Linear discriminant, functions and Fisher's linear discriminant, C4.5 algorithm tree, K-nearest neighbor, Weighted K-nearest neighbor, Hierarchical clustering algorithm, Gaussian Mixed Model (GMM), K-mean clustering algorithm, Ward's clustering algorithm, Minimum least square, Neural-Network or any combination thereof;
ix. means 209 for assigning said n dimensional volume to said specific bacteria;
c. means 300 for eliminating said water influence from said AS selected from a group consisting of; Low pass filter, High pass filter and Water absorption division
d. means 400 for data processing said AS without said water influence; said means 400 are characterized by:
i. means 401 for noise reducing by using different smoothing techniques selected from a group consisting of running average savitzky-golay, low pass filter or any combination thereof;
ii. means 402 for extracting m features from said entire AS; said m features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (m,s,Ai), different peaks' intensity ratios, wavelet coefficients or any combination thereof; m is an integer greater than or equal to one;
iii. means 403 for dividing said AS into several segments according to said m features;
iv. means 404 for calculating m₁ features at least one of said segments; said m₁ features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (m,s,Ai), different peaks' intensity ratios, wavelet coefficients or any combination thereof; m₁ is an integer greater than or equal to one; and,
e. means 500 for detecting and/or identifying said specific bacteria if said m₁ features and/or said m features are within said n dimensional volume;
wherein said bacteria is a antibiotics resistance bacteria.

28. The system 2000 according to claim 27, additionally comprising means for selecting said x feature and/or said y features via algorithms selected form Chi-Squared, c2, test, Wilcoxon test, and t-test or any combination thereof.

29. The system 2000 according to claim 27, wherein said sample is an aerosol or solid or liquid sample selected from a group consisting of cough, sneeze, saliva, mucus, bile, urine, vaginal secretions, middle ear aspirate, pus, pleural effusions, synovial fluid, abscesses, cavity swabs, serum, blood and spinal fluid.

30. The system 2000 according to claim 27, wherein said statistical processing means 200 additionally comprising means 210 for calculating the Gaussian distribution or Multivariate Gaussian distribution, or Rayleigh distribution, or Maxwell distribution, or Estimate the distribution by the Parzen method or by mixed model (like the Gaussian Mixed Model known as GMM) for at least one of the n features such that the distributions defines the n dimensional volume in the n dimensional space.

31. The system 2000 according to claim 27, wherein said means 400 for data processing said AS without said water influence additionally comprising:
i. means 405 for calculating at least one of the o^{th} derivative of said AS; said o is an integer greater than or equals 1;
ii. means 406 for extracting m₂ features from said entire o^{th} derivative spectrum; said m₂ features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (m,s,Ai), different peaks' intensity ratios, wavelet coefficients or any combination thereof m₂ is an integer greater than or equal to one;
iii. means 407 for dividing said o^{th} derivative into several segments according to said m₂ features;
iv. means 408 for calculating the m₃ features from at least one of said segments; said m₃ features are selected from a group consisting of Correlation, peak's wavelength, peak's height, peak's width, peak's cross section, peak's area, at least one of the coefficients of a fitted polynomial curve, the total sum of areas under at least two peaks of the signal, linear prediction coefficient (LPC), mean value of the signal, Variance value of the signal, Skewness value, Kurtosis value, Gaussians' set of parameters (m,s,Ai), different peaks' intensity ratios, wavelet coefficients or any combination thereof; m₂ is an integer greater than or equal to one; and,
v. Means 409 for detecting and/or identifying said specific bacteria if said m₁ and/or m₃ features and/or said m and/or said m₂ features are within said n dimensional volume.

32. The system 2000 according to claim 27, wherein said specific bacteria is selected from a is selected from a group consisting of Gram negative pathogens such as Various types of Acinetobacter, A. baumannii), Stenotrophomonas maltophilia, Gram positive pathogens such as Streptococcus pneumonia resistant to b lactamase and macrolides, Streptococcus viridians group resistant to b lactamase and aminoglycosides, enterococci resistant to vancomycin and teicoplanin and highly resistant to penicillins and aminoglycosides, Enterococcus Faecium, Enterococcus Faecalis, staphylococcus aureus, B lactams, macrolides, lincosamides and aminoglicozides, Streptococcus pyogenes resistant to macrolides, macrolide-resistant streptococci of groups B, C and G. Coagulase negative staphylococci resistant to b lactams, aminoglycosides, macrolides, lincosamides and glycopeptides, multiresistant strains of Listeria and corynebacterium, Peptostreptococcus and clostridium, C. Difficile, resistant to penicillins and macrolides, Haemophilus Influenza resistant to b lactamase, Pseudomonas Aeruginosa, Stenotrophomonas Maltophilia, Klebsiella Pneumonia resistant to antibiotics, Klebsiella Pneumonia Resistant to carbapenem, Klebsiella Pneumonia sensitive to antibiotics, aminoglycosides and macrolides or any combination thereof.

33. The system 2000 according to claim 27, wherein said means 100 for obtaining an absorption spectrum (AS) of said sample additionally comprising:
a. at least one optical cell for accommodating said uncultured sample;
b. p light source selected from a group consisting of laser, lamp, LEDs tunable lasers, monochrimator, p is an integer equal or greater than 1; said p light source are adapted to emit light at different wavelength to said optical cell; and,
c. Detecting means for receiving the spectroscopic data of said sample exiting from said optical cell.

34. The system 2000 according to claim 33, wherein said p light source are adapted to emit light at wavelength range selected from a group consisting of UV, visible, IR, mid-IR, far-IR and terahertz.

35. The system according to claim 19, wherein at least one is being held true: (a) the absorption spectra is obtained using an instrument selected from the group consisting of a spectrometer, Fourier transform infrared spectrometer, a fluorometer and a Raman spectrometer; (b) said sample is taken from the hum 1 body: and any combination thereof.

36. (canceled)

37. The system according to claim 19, additionally comprising means adapted to recommend, after the specific bacteria has been identified, what kind of antibiotics and medicine to take.

38. The method according to claim 1, additionally comprising at least one step selected from (a) recommending, after the specific bacteria has been identified, what kind of antibiotics and medicine to take, (b) obtaining said sample from air moisture and/or contaminations in air condition systems; (c) detecting said bacteria analyzing said AS in the canon about 3000-3300 cm⁻¹ and/or about 850-1000 cm⁻¹ and/or about 1300-1350 cm⁻¹, and/or about 2835-2995 cm⁻¹, and/or about 1720-1780 cm⁻¹, and/or about 1550-1650 cm⁻¹, and/or about 1235-11363 cm⁻¹, and/or about 990-1190 cm⁻¹ and/or about 1500-1800 cm⁻¹ and/or about 2800-3050 cm⁻¹ and/or about 1180-1290 cm⁻¹; and any combination thereof.

39. The system according to claim 19, wherein at least one is being held true (a) said sample is a sample obtained from air moisture and/or contaminations in air condition systems; (b) said identification is preformed in the region of about 3000-3300 cm⁻or about 850-1000 cm⁻¹ and/or about 1300-1350 cm⁻¹ and/or about 2836-2995 cm⁻¹, and/or about 1720-1780 cm⁻¹, and/or about 1550-1650 cm⁻¹, and/or about 1235-1363 cm⁻¹, and/or about 990-1190 cm⁻¹ and/or about 1500-1800 cm⁻¹ and/or about 2800-3050 cm⁻¹ and/or about 1180-1290 cm⁻¹; and any combination thereof.

40-42. (canceled)

43. The method for detecting and/or identifying specific bacteria within an uncultured sample according to claim 9, wherein at least one is being held true (a) the absorption spectra is obtained using an instrument selected from the group consisting of a spectrometer, Fourier transform infrared spectrometer, a fluorometer and a Raman spectrometer; (b) said sample is taken from the human body; (c) said method additionally comprising step of recommending, after the specific bacteria has been identified, what kind of antibiotics and medicine to take; (d) said sample is obtained from air moisture and/or contaminations in air condition systems; (e) said method additionally comprising the step of detecting said bacteria by analyzing said AS in the region of about 3000-3300 cm⁻¹ and/or about 850-1000 cm⁻¹ and/or about 1300-1350 cm⁻¹, and/or about 2836-2995 cm⁻¹, and/or about 1720-1780 cm⁻¹, and/or about 1550-1650 cm⁻¹, and/or about 1235-1363 cm⁻¹, and/or about 990-1190 cm⁻¹ and/or about 1500-1800 cm⁻¹ and/or about 2800-3050 cm⁻¹ and/or about 1180-1290 cm⁻¹; and any combination thereof

44. The system according to claim 27, wherein at least one is being held true (a) the absorption spectra is obtained using an instrument selected from the group consisting of a spectrometer, Fourier transform infrared spectrometer, a fluorometer and a Raman spectrometer; (b) said sample is taken from the human body; (c) said system additionally comprising means adapted to recommend, after the specific bacteria has been identified, what kind of antibiotics and medicine to take; (d) said sample is obtained from air moisture and/or contaminations in air condition systems; (e) said identification is preformed in the region of about 3000-3300 cm⁻¹ and/or about 850-1000 cm⁻¹ and/or about 1300-1350 cm⁻¹, and/or about 2836-2995 cm⁻¹, and/or about 1720-1780 cm⁻¹, and/or about 1550-1650 cm⁻¹, and/or about 1235-1363 cm⁻¹, and/or about 990-1190 cm⁻¹ and/or about 1500-1800 cm⁻¹ and/or about 2800-3050 cm⁻¹ and/or about 1180-1290 cm⁻¹; and any combination thereof.
